(19) United States
(12) Patent Application Publication
(10) Pub. No.: US 2012/0282578 A1
(43) Pub. Date: Nov. 8, 2012

(54) SYSTEM FOR STRATEGIC MEMORY AND REASONING (SMART)

(75) Inventors: Sandra B. Chapman, Dallas, TX (US); Jacquelyn F. Gamino, Dallas, TX (US)

(73) Assignee: THE BOARD OF REGENTS OF THE UNIVERSITY OF TEXAS SYSTEM, Austin, TX (US)

(21) Appl. No.: 13/392,524

(22) PCT Filed: Aug. 26, 2010
(86) PCT No.: PCT/US10/46849

§ 371 Date: May 8, 2012

Related U.S. Application Data
(60) Provisional application No. 61/237,525, filed on Aug. 27, 2009.

(51) Int. Cl. G09B 17/00

(52) U.S. Cl. 434/178

(57) ABSTRACT

A cognitive strategy instruction program focusing specifically on the ability to reason, abstract, and generalize information for more efficient learning is described herein. The combination of the strategies in tandem with the intensive presentation and process-related (rather than content-related) approach are unique to the SMART program of the present invention. The SMART approach encompasses various cognitive processes in succession, such as working memory, attention, and synthesis of pre-existing knowledge with new information in contrast to most current cognitive interventions focus on specific aspects of cognition such as working memory in isolation. The SMART program of the present invention can be extended with slight modifications if necessary to adults, particularly in senior citizens to enhance one or more cognitive processes.

### TECHNICAL FIELD OF THE INVENTION

The present invention relates in general to the field of learning strategies, and more particularly to the design and development of a novel cognitive strategy instruction program that focuses specifically on the ability to reason, abstract, and generalize information for more efficient learning.

### BACKGROUND ART

Without limiting the scope of the invention, its background is described in connection with cognition and learning strategies and tools.

U.S. Patent Application Publication No. 20080220399 (Kayode, 2008) discloses an educational conceptual framework in the form of a game, which incorporates movement or interaction for the participants as a key part of the learning process through two phases. The learning process described involves a given ‘scenario card’ which describes a situation from any venue of life. The participants read the initial ‘scenario card’ and on a turn basis select a ‘movement card’ which help said participants move from ‘station card’ to ‘station card’. This is known as phase one of the exercise. Each participant retains every ‘movement card’ selected. In phase two there are ‘critical thinking cards’ which correspond specifically to a particular ‘movement card’ utilized in phase one. The instructor, the teacher or the counselor then generates and completes an analytical discussion of decisions made with the aid of the ‘critical thinking cards’, on a turn basis with each participant. On completion of the discussion the exercise is finished.

U.S. Pat. No. 5,980,354 issued to Prest (1999) (hereinafter '354 patent) pertains to educational toys and methods for nurturing cognitive development of preschool children. More particularly, the educational toys of the present invention are characterized by the variety of their auxiliary signs by which a child can develop learning strategies. The '354 patent describes a cognition nurturing toy comprising at least one rigid board having a series of cavities therein, with each cavity having a distinct outline belonging to a first set. There is also provided a series of colorful illustrations printed on the board with each illustration encompassing one cavity. Each illustration in the series is arranged on the rigid board in a coherent order portraying at least one environment. The patent also provides a method for nurturing learning strategies, primarily by providing a child with a multiplicity of auxiliary signs such that the child can develop an awareness to alternate recourse for associating new experiences to existing knowledge.

### DISCLOSURE OF THE INVENTION

The SMART program of the present invention is an instructional tool developed to improve reasoning and critical thinking. In essence, SMART program of the present invention teaches children and adults how to learn and think about information to improve learning ability and reasoning

In one embodiment the present invention describes a method for enhancing one or more cognitive processes in a subject comprising: providing the subject with a reading segment to read having known information and requesting the subject to perform one or more of the following steps: (i) inhibiting/selecting deleting/inhibiting unimportant details and prioritize important information from the reading segment and documenting the subject's prioritization response, (ii) organizing important information from the reading segment into a hierarchical listing and documenting the subject's organization response, (iii) generating an inference to extract a deeper/abstract meaning of information in the reading segment and documenting the subject's inference response, (iv) paraphrasing in their own words the subject matter disclosed in the reading segment and documenting the subject's paraphrase response, (v) combining and connecting details from reading segment, combining details together into one or more concepts, using inferencing and paraphrasing, and documenting the subject's concept response, (vi) integrating the subject's previous knowledge with new information from reading segment to formulate a high-level concepts, and documenting the subject's integration response, and (vii) generalizing the abstract ideas with supporting key points from the reading segment, and documenting the subject's generalization response.

In one aspect of the method of the present invention each step is done in a different work session. In another aspect the one or more steps are conducted in one or more work sessions. In yet another aspect each step is conducted in a single work session. In a specific aspect of the method of the present invention each step is documented on one or more worksheets.

In one aspect the reading segment of the method of the present invention the reading segment comprises one or more stories, wherein the reading segment is selected based on the reading level of the subject. In another aspect the reading segment comprises a book, a magazine, an article, a newspaper, a paper based reading material, an electronic book, a local computer or computer program, a web-based computer program, a video, a sound, a picture, a photograph, and combinations and modifications thereof.

In an other embodiment the present invention is a system for enhancing one or more cognitive processes in a subject, comprising: a delivery device that provides or displays a reading segment having known information, wherein the delivery device is selected from the group consisting of a teacher, a counselor, a tutor, a therapist, a doctor, a psychologist, a data processor, any suitable human subject, a computer, a phone, a television, a video, a DVD, a CD, a Blu-ray disc, a media storage device, a photograph, a web-based system, and combinations and modifications thereof, and one or more electronic worksheets for documenting the subject's responses to one or more of the following tasks: (i) inhibiting/selecting or deleting/inhibiting unimportant details and prioritize important information from the reading segment and documenting the subject's prioritization response, (ii) organizing important information from the reading segment into a hierarchical listing and documenting the subject's organization response, (iii) generating an inference to extract a deeper/abstract meaning of information in the reading segment and documenting the subject's inference response, (iv) paraphrasing in their own words the subject matter disclosed in the reading segment and documenting the subject's paraphrase response, (v) combining and connecting details from reading segment, combining details together into one or more concepts, using inferencing and paraphrasing, and documenting the subject's concept response, (vi) integrating the subject's previous knowledge with new information from reading segment to formulate a high-level concepts, and documenting the subject's integration response, and (vii) generalizing the abstract ideas with supporting key points from the reading segment, and documenting the subject's generalization response.

One aspect of the system of the present involved conducting each step is conducted in a different work session. In another aspect one or more steps are conducted in one or more work sessions. In yet another aspect of the system of the present invention each step is conducted in a single work session. One aspect of the system of the present involves documenting each step on one or more worksheets. In another aspect the reading segment comprises a book, a magazine, an article, a newspaper, a paper based reading material, an electronic book, a local computer or computer program, a web-based computer program, a video, a sound, a picture, a photograph, and combinations and modifications thereof. In another aspect the reading segment of the system of the present invention comprises one or more stories, wherein the reading segment is selected based on the reading level of the subject.

In yet another embodiment the present invention discloses a system for enhancing one or more cognitive processes in a subject, comprising: a reading segment module comprising one or more stories and a documentation module comprising one or more worksheets for documenting the subject's responses to one or more of the following modules based on the one or more stories: (i) an inhibition/selection deletion/inhibition module that comprises worksheets for documenting the subject's answers to questions that define unimportant details and prioritization information, (ii) an organizational module that comprises worksheets for documenting the subject's answers to questions that define a hierarchical listing, (iii) an inference module that comprises worksheets for documenting the subject's answers to questions that define a deeper/abstract meaning of information in the reading segment, (iv) a paraphrasing module that comprises worksheets for documenting the subject's paraphrase of the one or more stories, (v) a combination and connection module that comprises worksheets for documenting the subject's answers to questions that combine one or more details from the reading segment together with one or more concepts, using inferencing and paraphrasing, (vi) an integration module that comprises worksheets for documenting the subject's answers to questions that document the subject's previous knowledge with new information from the reading segment to formulate a high-level concepts, and (vii) a generalization module that comprises worksheets for documenting the subject's answers to questions that document the subject's understanding of abstract ideas with supporting key points from the reading segment.

In one aspect of the system of the present invention each step is conducted in a different work session. In another aspect of the system of the present invention the one or more steps are conducted in one or more work sessions. In yet another aspect of the present invention each step is conducted in a single work session. In a specific aspect of the system of the present invention each step is documented on one or more worksheets. In one aspect the reading segment of the system of the present invention comprises one or more stories and further comprises the step of selecting the reading segments based on the reading level of the subject. In another aspect the reading segment comprises a book, a magazine, an article, a newspaper, a paper based reading material, an electronic book, a local computer or computer program, a web-based computer program, a video, a sound, a picture, a photograph, and combinations and modifications thereof.

One embodiment of the present invention relates to a method for enhancing one or more cognitive processes in a subject comprising the steps of: providing the subject with a reading segment to read having known information and requesting the subject to perform one or more of the following steps: (i) filtering/blocking out/deleting unimportant details and identifying important or main details from the reading segment and documenting the subject's filtering response, (ii) focusing on the important or main details from the reading segment by organizing the details into one or more chunks, categories, listings or concepts and documenting the subject's focusing response, (iii) generating a synopsis, a summary or an interpretation of the important details or the main concept by linking the organized details with the subject's previously obtained concepts, knowledge or experience and documenting the subject's interpretation response, (iv) strengthening the synopsis, the summary or the interpretation by zooming in and zooming out to obtain a gist of the reading segment and documenting the subject's zooming in and zooming out response, and (v) discovering a deeper meaning, understanding or an interpretation of the important details or the main concept and documenting the subject's discovering response. The subject described hereinabove is an adult human subject. In one aspect the one or more cognitive processes comprise brain functions, problem solving skills, high-level thinking skills, reasoning skills or combinations thereof. In another aspect each step is conducted in a different work session. In another aspect one or more steps are conducted in one or more work sessions. In yet another aspect each step is conducted in a single work session and is documented on one or more worksheets. In a related aspect the reading segment comprises a book, a magazine, an article, a newspaper, a paper based reading material, an electronic book, a local computer or computer program, a web-based computer program, a video, a sound, a picture, a photograph, and combinations and modifications thereof.

Another embodiment of the present invention describes a system for enhancing one or more cognitive processes in a subject comprising: (i) a delivery device that provides or displays a reading segment having known information, wherein the delivery device is selected from the group consisting of a data processor, a display, a computer, a phone, a smartphone, a television, a video, a DVD, a CD, a Blu-ray disc, a media storage device, a photograph, a web-based system, and combinations and modifications thereof and one or more electronic worksheets for documenting the subject's responses to one or more of the following tasks: (i) filtering/blocking out/deleting unimportant details and identifying important or main details from the reading segment and documenting the subject's filtering response, (ii) focusing on the important or main details from the reading segment by organizing the details into one or more chunks, categories, listings or concepts and documenting the subject's focusing response, (iii) generating a synopsis, a summary or an interpretation of the important details or the main concept by linking the organized details with the subject's previously obtained concepts, knowledge or experience and documenting the subject's interpretation response, (iv) strengthening the synopsis, the summary or the interpretation by zooming in and zooming out to obtain a gist of the reading segment and documenting the subject's zooming in and zooming out response, and (v) discovering a deeper meaning, understanding or an interpretation of the important details or the main concept and documenting the subject's discovering response. In one aspect the subject is an adult human subject. In another aspect the one or more cognitive processes comprise brain functions, problem solving skills, high-level thinking skills, reasoning skills or combinations thereof. In yet another aspect the reading segment comprises a book, a magazine, an article, a newspaper, a paper based reading material, an electronic book, a local computer or computer program, a web-based computer program, a video, a sound, a picture, a photograph, and combinations and modifications thereof.

In yet another embodiment the instant invention discloses a system for enhancing one or more cognitive processes in a subject, comprising: a reading segment module comprising one or more stories, newspaper articles, magazine articles, literary works, current affairs, pictures, images, cartoons and combinations thereof, a documentation module comprising one or more worksheets for documenting the subject's responses to one or more of the following modules based on the reading segment modules, a filtering/blocking out/deleting module that comprises worksheets for documenting the subject's answers to questions that define unimportant details and prioritization information, a focusing module that comprises worksheets for documenting the subject's answers to questions that define an organizational ability, an integration module that comprises worksheets for documenting the subject's answers to questions that document the subject's previous knowledge with new information from the reading segment to formulate a high-level concept, a synopsis module that comprises worksheets for documenting the subject's answers to questions that define an interpretation of information in the reading segment, and a discovery module that comprises worksheets for documenting the subject's deeper understanding of the reading segment. In one aspect the subject is an adult human subject. In another aspect the one or more cognitive processes comprise brain functions, problem solving skills, high-level thinking skills, reasoning skills or combinations thereof.

### DESCRIPTION OF THE DRAWINGS

For a more complete understanding of the features and advantages of the present invention, reference is now made to the detailed description of the invention along with the accompanying figures and in which:

FIG. 1 is a schematic showing the different steps of the SMART strategy of the present invention;

FIG. 2 is a flow chart depicting the different cognitive strategies of the present invention and their relationships;

FIG. 3 is a schematic showing the outline of the different steps involved in the Inhibit/Select stage of the SMART strategy of the present invention;

FIG. 4 is a schematic showing the outline of the different steps involved in the Organize stage of the SMART strategy of the present invention:

FIG. 5 is a schematic showing the outline of the different steps involved in the Inference stage of the SMART strategy of the present invention;

FIG. 6 is a schematic showing the outline of the different steps involved in the Paraphrasing stage of the SMART strategy of the present invention;

FIG. 7 is a schematic showing the outline of the different steps involved in the Combine/Connect stage of the SMART strategy of the present invention

FIG. 8 is a schematic showing the outline of the different steps involved in the Integrate stage of the SMART strategy of the present invention;

FIGS. 9A-9D is a schematic showing the outline of the different steps involved in the Generalize stage of the SMART strategy of the present invention;

FIG. 10 is a schematic showing the different components or modules and their inter-relationships of an online SMART system;

FIG. 11 is a schematic representation of strategies of the SMART program to enhance one or more cognitive processes in adults;

FIG. 12 is a schematic of the use and dynamic flow of the three core cognitive processes, i.e., (i) strategic attention, (ii) integrated reasoning, and (iii) elaborated reasoning essential to engaging strategic gist reasoning as described in the present invention;

FIG. 13 shows a topographical map and ERP waveforms showing differences in bilateral frontal regions (at electrodes F1, F2, AF3, and AF4) between gist versus detail processing during 690-1070 ms; and

FIG. 14 shows contrast maps of areas of significantly greater activation in frontal and temporal regions when hemodynamic responses elicited by processing of gist and detail were statistically compared (p<0.05, FDR Corrected).

### DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The present invention describes the design and the development of a Strategic Memory and Reasoning Training (SMART) program. The program of the present invention is an instructional tool developed to improve reasoning and critical thinking. In essence, SMART teaches children or adults (including senior citizens) how to learn and think about information to improve learning ability and reasoning. Conversely, many education programs focus on “what to learn” not “how to learn”.

An integral part of the SMART program of the instant invention is the Test of Strategic Learning (TOSL). The TOSL program or its derivatives may be delivered by paper, web or other electronic methods. In addition to the TOSL, the present inventors have added an optional component called “Brain Boosters” to the SMART program of the instant invention. The concept of Brain Boosters or extended sessions may not be included in every instance of the SMART program. Brain Boosters are intended to extend the knowledge and skill set of the subject and may be delivered in face-to-face sessions, via postal delivery, email or web interfaces, computer and video based delivery methods, etc.

The modules, methods and programs of the present invention comprises explanations of seven cognitive strategies as well as tasks to train and improve reasoning abilities. The delivery system for these modules, methods, and programs is selected from the group consisting of a teacher, a counselor, a tutor, a therapist, a doctor, a psychologist, a data processor, any suitable human subject, a computer, a phone, a television, a video, a DVD, a CD, a Blu-ray disc, a media storage device, a photograph, a web-based system, and combinations and modifications thereof. The tasks can be performed by a simple pencil and paper or can involve used of other modes like local computers or a network, a web based program, a DVD, a board game, a phone or other manipulatives thereof. The strategies are based on cognitive science research in text processing and memory function. The strategies are taught in a hierarchical manner to improve higher order cognitive processing. Original texts are used to practice the newly learned strategies. Every strategy is practiced and incorporated into subsequent strategy instruction to solidify the application of more efficient use of cognitive processes.

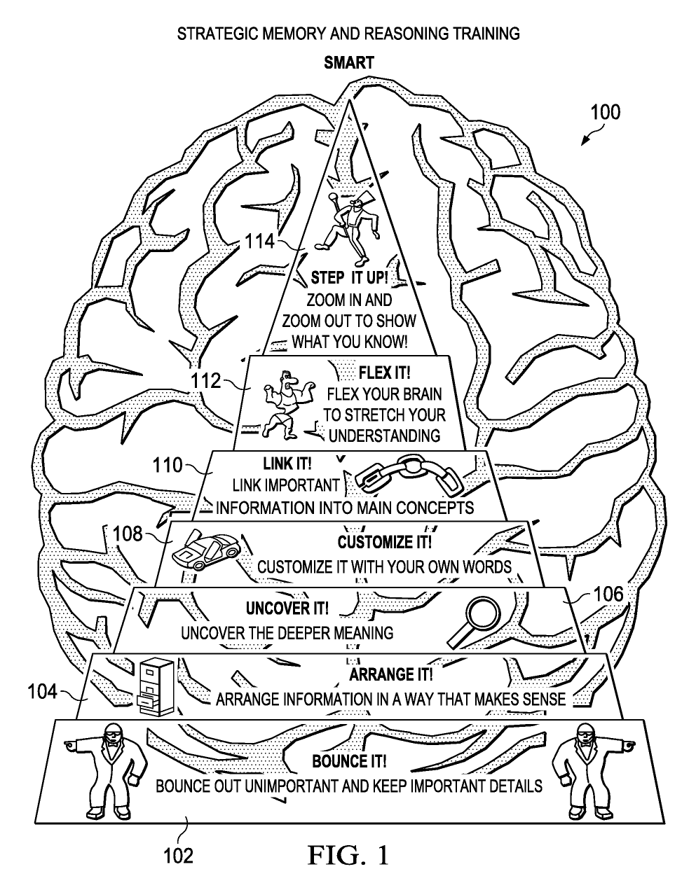

FIG. 1 is a schematic showing the different steps of the SMART strategy 100 of the present invention. The strategy 100 comprises the following elements of: (102) “BOUNCE IT” (bounce out unimportant and keep important details), (104) “ARRANGE IT” (arrange information in a way that it makes sense), (106) “UNCOVER IT” (uncover the deeper meaning), (108) “CUSTOMIZE IT” (customize it with your own words), (110) “LINK IT” (link important information into main concepts), (112) “FLEX IT” (flex your brain to stretch your understanding), and (114) “STEP IT UP” (zoom in and zoom out to show what you know).

Each individual strategy of the present invention is taught and practiced over the course of a 45 minute to 1 hour sessions. The program consists of 10 sessions wherein the utilization of the strategies are practiced and honed. Each strategy instruction session of the present invention begins with an explanation and practice of the strategy on a basic level progressing rapidly to connected texts. The 10 sessions take place over the course of a one month time period. Three additional sessions (beyond the initial strategy instruction) focus on the processes involved in strategic learning such that the subject is provided with the chance to repeat the strategies across subjects and contexts.

Constructing the central meaning is at the heart of communicative and learning competence blending linguistic, cognitive, and social abilities. In the current academic climate, wherein standardized, mandatory achievement tests are the norm, classroom instruction all too often emphasizes the regurgitation of facts rather than deeper processing and understanding of information. As a result, children are failing to develop higher order critical thinking and reasoning skills. Higher order critical thinking and reasoning ability allows the subject to use cognitive resources more efficiently by organizing isolated details into larger concepts. Thus, reasoning and critical thinking help the subject process information at a deeper level, improving understanding and retention.

The ability to reason and think critically is essential to many if not all aspects of life. We define reasoning as the ability to hold and manipulate information, analyze the components and synthesize new information with world knowledge into novel concepts or solutions to problems. Thus, reasoning is a broad term that incorporates executive functions of cognitive control that in isolation may appear simplistic but when integrated allow the complex higher order cognitive processes that facilitate problem solving and innovation. From an academic standpoint, reasoning allows reading comprehension, mathematical computation, scientific understanding, and generalized problem solving ability. From a social cognition perspective, reasoning is a necessary component of theory of mind.

Reasoning is a complex executive function that involves planning, organizing and the ability to maintain goal-relevant behavior. Reasoning necessitates holding and manipulating newly acquired information for synthesis with world knowledge, thereby allowing for the cognitive ability to abstract inferences, conclusions or judgments. Reasoning allows novel interpretation, critical thinking, and deeper understanding of information. Reasoning is associated with prefrontal cortical activation, is dependent on working memory, and is integral to problem solving. As such, reasoning requires the ability to plan and self-regulate in order to organize and manipulate goals and subgoals.

Reasoning requires the ability to selectively attend to information, while inhibiting or ignoring irrelevant or unnecessary information in order to efficiently utilize working memory capacity to integrate and synthesize new with existing knowledge. The cognitive domains of attention, inhibition, and working memory must in fact work in tandem in order to achieve successful reasoning. Thus, the complexities of reasoning processes are greater than the sum of its parts.

In middle and high school years, the ability to understand the central meaning through reasoning becomes even more crucial for academic success and performance As the school curricula changes, students must integrate and synthesize vast amounts of information from teachers' lectures and textbooks. Children who struggle with reasoning to understand and construct a central meaning may fall behind in school. Often, impairment in reasoning eludes diagnosis and therefore, treatment. Reasoning impairments can be difficult to pinpoint in typical standardized testing, yet they can have a pronounced effect on long-term learning, social interaction skills, and occupational success.

Thus, instruction of cognitive strategies that promote reasoning must allow for this flexibility of generalization rather than being tied to specific curriculum content. The SMART program of the present invention fills the critical void of explaining how to learn rather than what to learn.

The present inventors were motivated to develop the SMART program of the present invention by their research to improve impairments in reasoning abilities in subjects with Attention Deficit Hyperactivity Disorder (ADHD) and traumatic brain injury (TBI). The impetus for SMART of the present invention emerged from evidence of poor academic performance in children with ADHD and/or TBI despite normal intelligence. The present inventors determined that impaired reasoning was prevalent in pediatric ADHD and TBI.

Evidence suggests that there is a reasoning crisis in the United States, wherein otherwise intelligent children are not developing the skills of higher order cognitive processing. Under-developed reasoning abilities may be due in part to the emphasis placed on standardized achievement tests that measure surface level, detail-based learning. Performance on state-mandated achievement tests are often given priority in the classroom, rather than teaching children to think critically and deeply about information.

The present inventors identified and isolated cognitive processes that have a theoretically driven and empirically evidenced contribution to reasoning ability based upon our research and the research of others. The inventors developed these cognitive processes into teachable strategies and made the strategies user friendly by developing phrases to identify each process using language that children easily understand and remember.

Each cognitive strategy is a separate unit within the SMART program of the present invention, such that it is introduced initially in isolation and subsequently combined with preceding strategies. Hence the program serves as a taxonomy for reasoning processes. After each strategy is explained, the subject is given specific instruction regarding the application of the strategy. Each strategy application begins with simplified examples and practice and is then presented in more complex contexts for further practice. The total time for each strategy instruction unit is approximately 45 minutes to 1 hour depending upon the subject's abilities. The final units of the SMART program are used to practice and solidify the strategies learned previously.

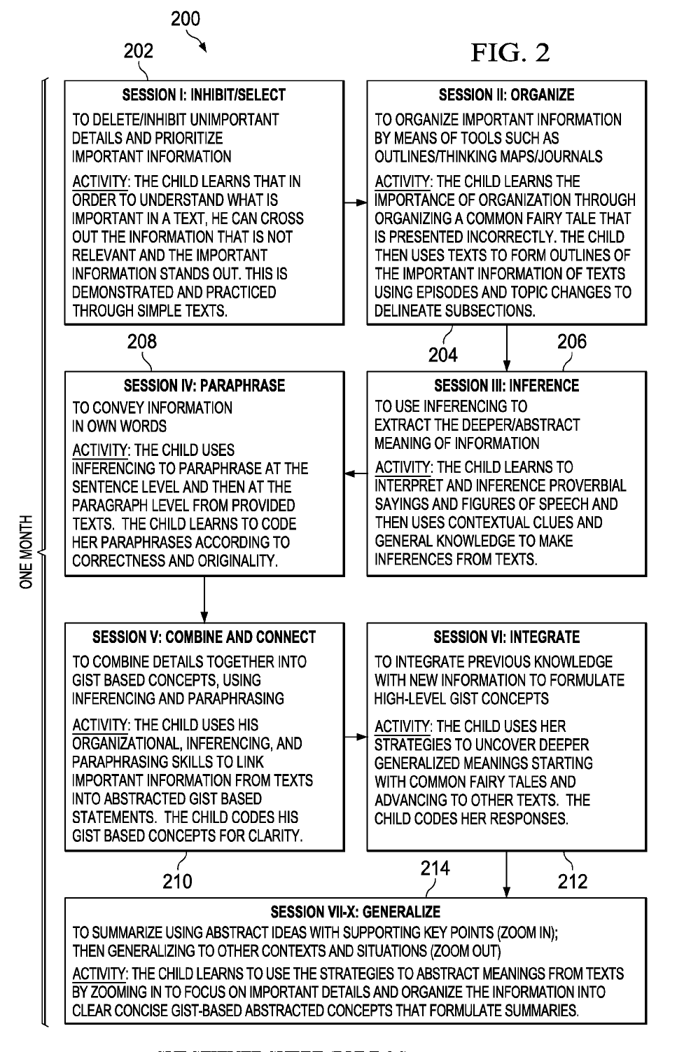

There are no existing cognitive interventions that focus on the ability to abstract information to enhance reasoning and higher order cognitive function. Children are often taught cognitive strategies in isolation, providing a limitation in the knowledge of how to combine and apply strategies across contexts. The SMART program of the present invention provides the opportunity to generalize cognitive concepts into many facets of life, educational, social, and occupational. In addition, the pencil and paper approach to teaching the SMART program are extremely cost effective. The specific cognitive strategies of the SMART program of the present invention are listed in Table 1 and are represented schematically in FIG. 2.

The different elements of the SMART program of the present invention are described below with illustrative examples. The examples presented below specifically describe the focus, the objectives and the activities performed in the individual sessions.

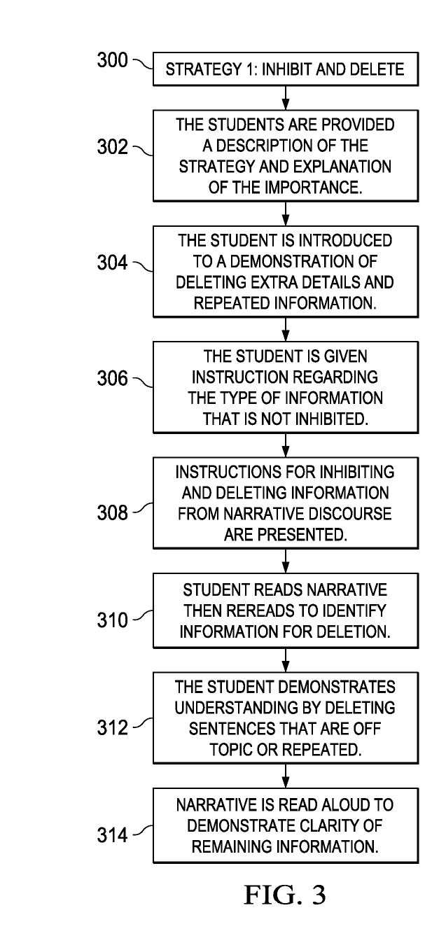

FIG. 3 is a schematic outline of the different steps that are performed in the Inhibit/Select stage 300 of the training. The focus in this stage is to delete/inhibit unimportant details and prioritize important information. The subject (or the student) learns that in order to understand what is important in a text, he/she can cross out the information that is not relevant and the important information stands out. This is demonstrated and practiced through simple texts. In step 302 of this stage the focus, the importance and the description of the strategy is provided to the subject. In step 304, the administrator provides a demonstration as to how extraneous details and repetitive information can be deleted. The subject is then provided with the practice or exercise narrative. In step 306, the subject is taught to identify information that is not inhibited or to be deleted (important or main details of the narrative). The subject is then given instruction as to how he or she can delete extraneous and repetitive information from the provided narrative (308). The subject then rereads the narrative to focus or identify the information to be deleted (step 310). In step 312 the subject actually performs the task of deleting the sentences that are off-topic or repeated. Finally, in step 314 the subject reads the modified narrative aloud to demonstrate the clarity of the remaining information.

TABLE 1
Seven cognitive strategies of the SMART program of the present invention.

| Stages of | | Session | |
|---|---|---|---|
| Training | Strategy | Number | Activity |
| 1. Inhibit/Select: | To delete/inhibit | One | The child learns that in order to understand |
| (202) | unimportant details and | | what is important in a text, he can cross out |
| | prioritize important | | the information that is not relevant and the |
| | information | | important information stands out. This is |
| | | | demonstrated and practiced through simple |
| | | | texts. |
| 2. Organize: | To organize important | Two | The child learns the importance of |
| (204) | information by means of | | organization through organizing a common |
| | tools such as | | fairy tale that is presented incorrectly. The |
| | outlines/thinking | | child then uses texts to form outlines of the |
| | maps/journals | | important information of texts using |
| | | | episodes and topic changes to delineate |
| | | | subsections |
| 3. Inference: | To use inferencing to | Three | The child learns to interpret and inference |
| (206) | extract the deeper/abstract | | proverbial sayings and figures of speech and |
| | meaning of information | | then uses contextual clues and general |
| | | | knowledge to make inferences from texts. |
| 4. Paraphrase: | To convey information in | Four | The child uses inferencing to paraphrase at |
| (208) | own words | | the sentence level and then at the paragraph |
| | | | level from provided texts. The child learns to |
| | | | code her paraphrases according to |
| | | | correctness and originality. |
| 5. Combine & | To combine details | Five | The child uses his organizational, |
| Connect: | together into gist based | | inferencing, and paraphrasing skills to link |
| (210) | concepts, using inferencing | | important information from texts into |
| | and paraphrasing | | abstracted gist based statements. The child |
| | | | codes his gist based concepts for clarity. |
| 6. Integrate: | To integrate previous | Six | The child uses her strategies to uncover |
| (212) | knowledge with new | | deeper generalized meanings starting with |
| | information to formulate | | common fairy tales and advancing to other |
| | high-level gist concepts | | texts. The child codes her responses. |
| 7: Generalize: | To summarize using | Seven-Ten | The child learns to use the strategies to |
| (214) | abstract ideas with | | abstract meanings from texts by zooming in |
| | supporting key points | | to focus on important details and organize |
| | (zoom in); then | | the information into clear concise gist-based |
| | generalizing to other | | abstracted concepts that formulate |
| | contexts and situations | | summaries. |
| | (zoom out) | | |

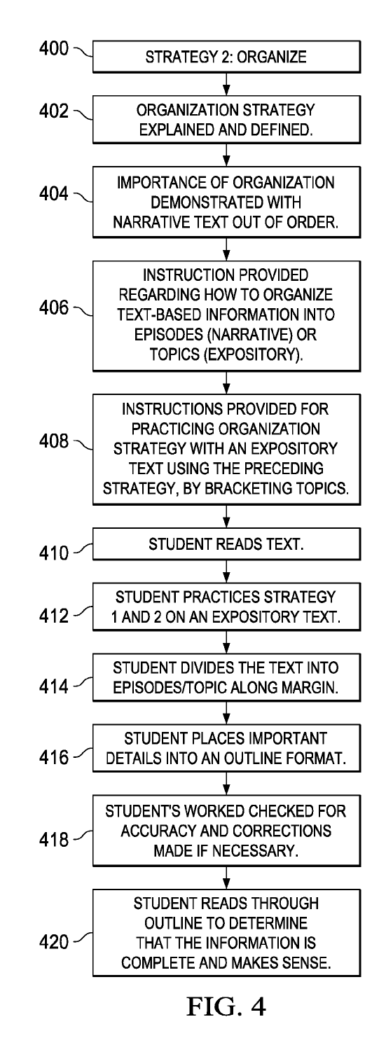

FIG. 4 is a schematic outline of the different steps that are performed in the Organize stage 400 of the training. In step 402 the organization strategy is defined and explained to the subject. In step 404 the importance of the organization strategy of step 402 is demonstrated using an example comprising a narrative wherein the text is out of order. In step 406, the subject is provided with instructions as to how he/she can organize the text-based information into either episodes (narratives) or as topics (expository). Instructions are also provided for practicing the organization strategy with an expository text using the strategy described hereinabove, by bracketing topics (step 408). The subject then reads a text in step 410 and practices the delete/inhibit strategy 300 and the organization strategy (400) on the expository text (step 412). The subject then divides the text into either episodes or topics along the margin in step 414. The subject then places the important details in an outline format in step 416. The instructor (administrator) then checks the work for accuracy and corrections are made if necessary in step 418. Finally, in step 420 the subject reads through the outline to determine that the information is complete and makes sense.

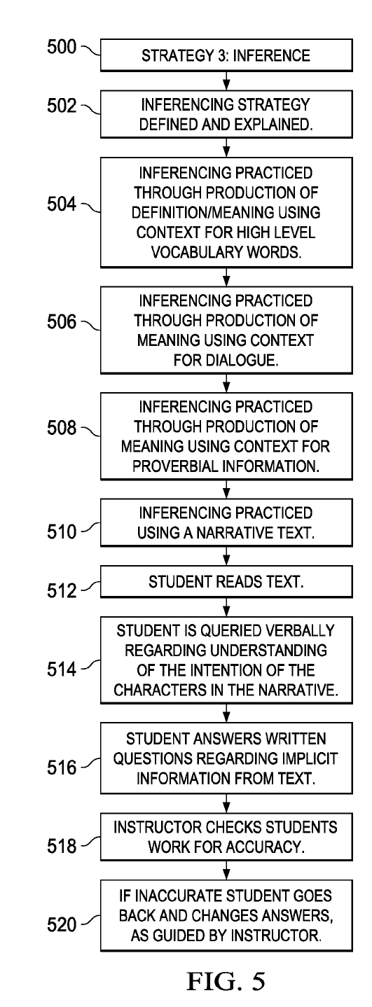

FIG. 5 is a schematic outline of the different steps that are performed in the Inference stage 500 of the training. The inferencing strategy 502 is explained to the subject in step 502, and is practiced through the production of definition/meaning using context for high level vocabulary words in step 504. The inferencing of further practices through production of meaning using context for dialogue (506) and for proverbial information (508). The subject then practices inferencing using a narrative text in step 510. In step 512 the subject reads the text. The instructor or administrator the quizzes the subject verbally regarding the understanding of the intention of the characters in the narrative in step 514. In step 516 the subject answers written questions based on the implicit information contained in the text of step 514. In step 518 the subject's work is checked for accuracy and if inaccurate the subject changes the answers as guided by the instructor in step 520.

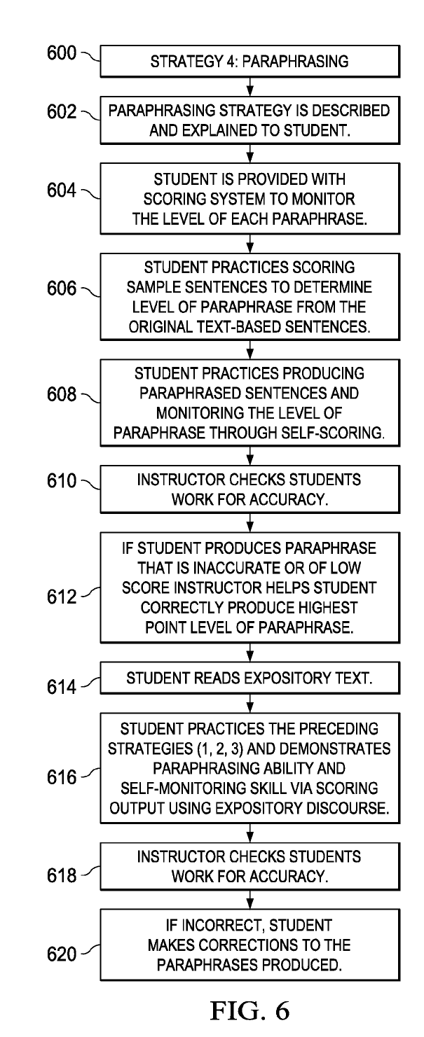

FIG. 6 is a schematic outline of the different steps that are performed in the Paraphrasing stage 600 of the training. In step 602 the paraphrasing strategy is explained to the subject, who is then provided with a scoring system to monitor the level of each paraphrase in step 604. The subject then practices the scoring of sample sentences to determine a level of paraphrase from the original text-based sentences (606). In step 608 the subjects practices producing paraphrased sentences and scores to self-monitor the level of paraphrasing. In step 610 the instructor checks the subjects work for accuracy and helps the subject to correctly produce the highest point level of paraphrase in the event of inaccurate or low score paraphrasing (612). In step 614 student reads an expository text and practices the strategies described hereinabove (300, 400, and 500) and demonstrates paraphrasing and self-monitoring abilities via scoring output using expository discourse. In step 618, the instructor again checks the work for accuracy and if incorrect the subject makes corrections to the paraphrase in step 620.

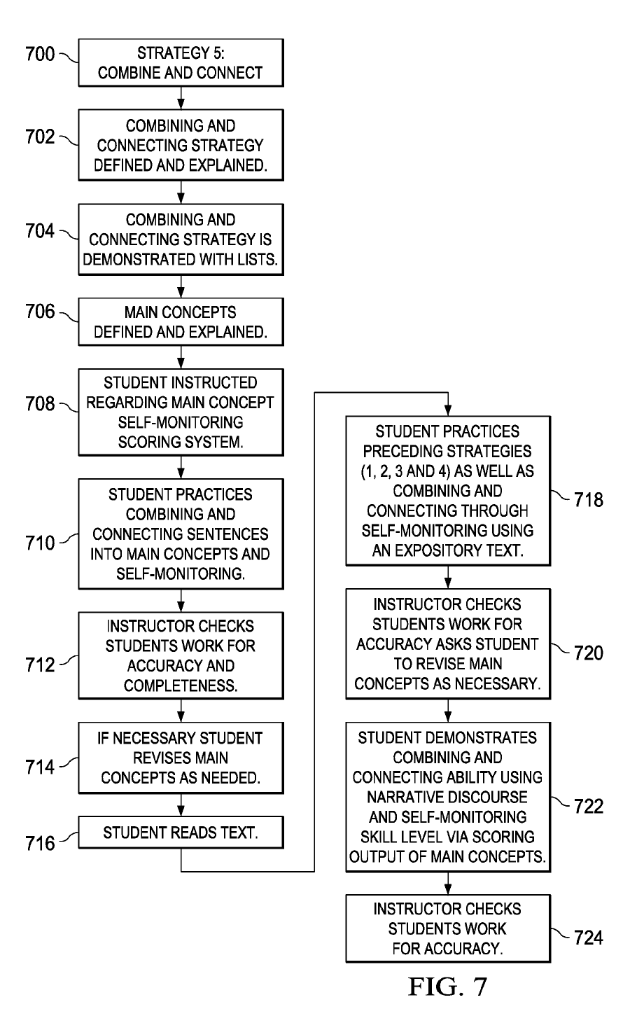

FIG. 7 is a schematic outline of the different steps that are performed in the Combine and Connect stage 700 of the training. The stage begins with the definition and explanation of the combine and connect strategy to the subject (step 702) followed by a demonstration using lists (step 704). The main concepts are defined and explained to the subject in step 706. The subject is then given detailed instructions regarding main-concept self-monitoring scoring system (step 708)/. In step 710 the subject practices combining and connecting sentences into main concepts and self-monitoring. In step 712 the instructor checks the subject's work for accuracy and completeness. In step 714 the subject revises the main concepts as needed. The subject then reads an expository text in step 716, and practices the strategies described hereinabove (300, 400, 500, and 600) as well as combining and connecting through self-monitoring using an expository text. In step 720 the instructor checks subject's work for accuracy and asks subject's to revise main concepts as necessary. In step 722 the subject demonstrates combining and connecting ability using a narrative discourse and self-monitoring skill level via a scoring output of main concepts. Finally, the instructor checks the subject's work for accuracy (step 724).

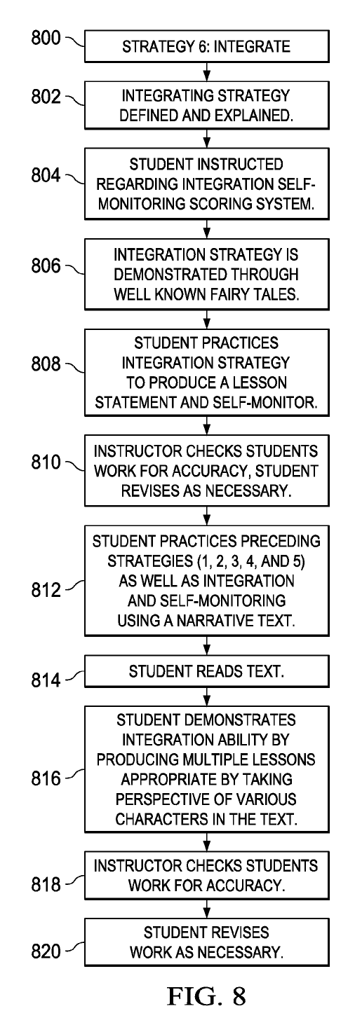

FIG. 8 is a schematic outline of the different steps that are performed in the Integrate stage 800 of the training. The integrate stage 800 comprises multiple steps. In step 802 the integrating strategy is defined and explained to the subject. In step 804 the subject is introduced and given instructions to the integration and self-monitoring tasks. Step 806 involves demonstration of the integration strategies through a narrative (for e.g., fairy tales). In step 808 the subject practices integration and self-monitoring through a lesson example. The instructor reviews and checks the subject's work for accuracy followed by revision if necessary by the subject in step 810. The subject then practices the different strategies described hereinabove (300, 400, 500, 600, and 700) and the integration and self-monitoring in step 812 using a narrative text. The subject then reads a narrative text in step 814, followed by a demonstration of integration ability by producing multiple lessons appropriate by taking the perspective of various characters in the text (step 816). The instructor checks the work for accuracy (818) followed by a revision by the subject if necessary (820).

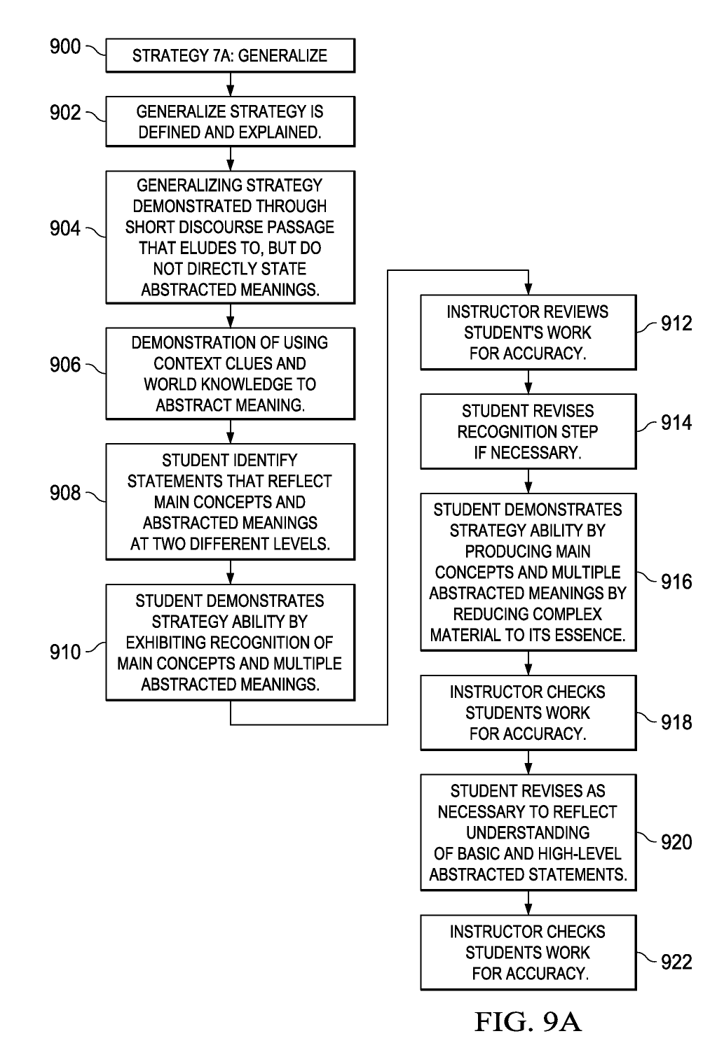

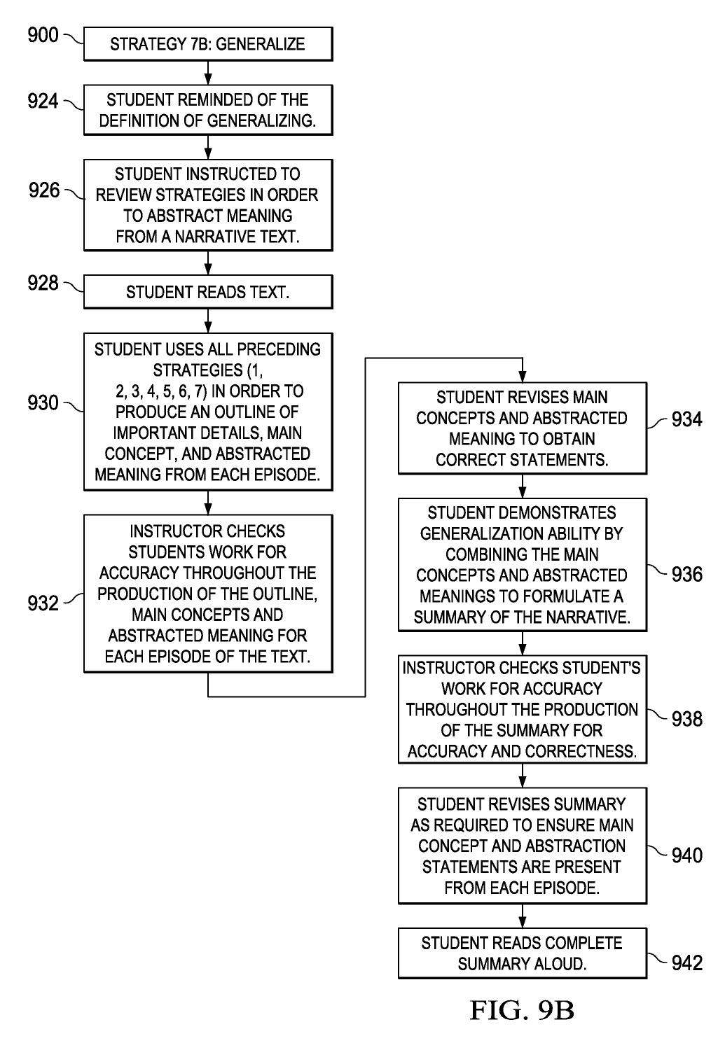

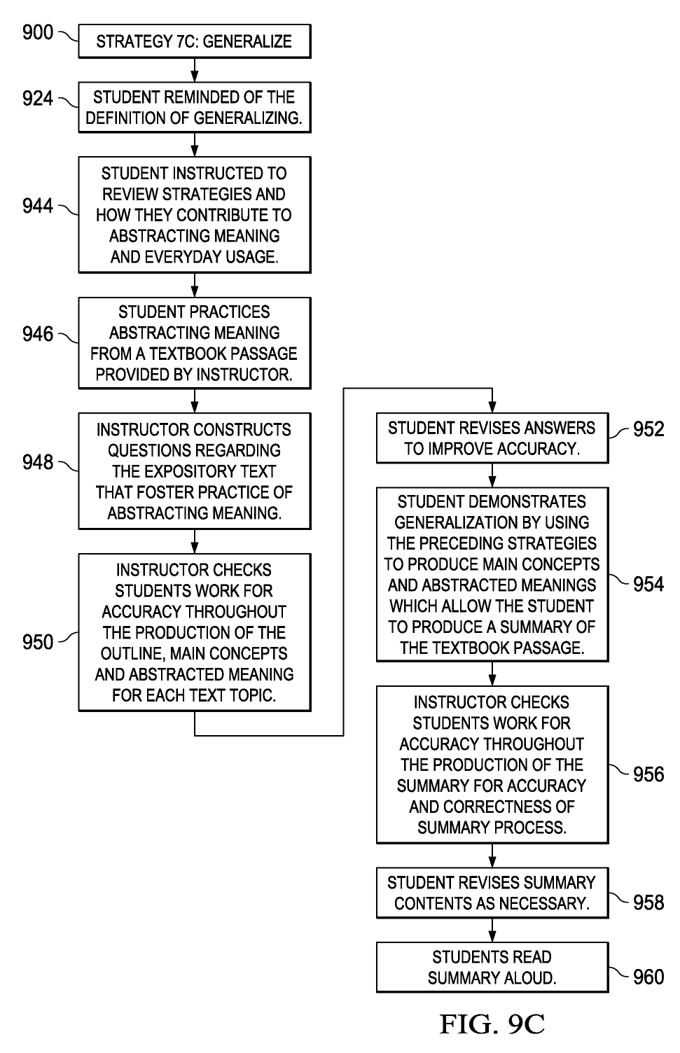

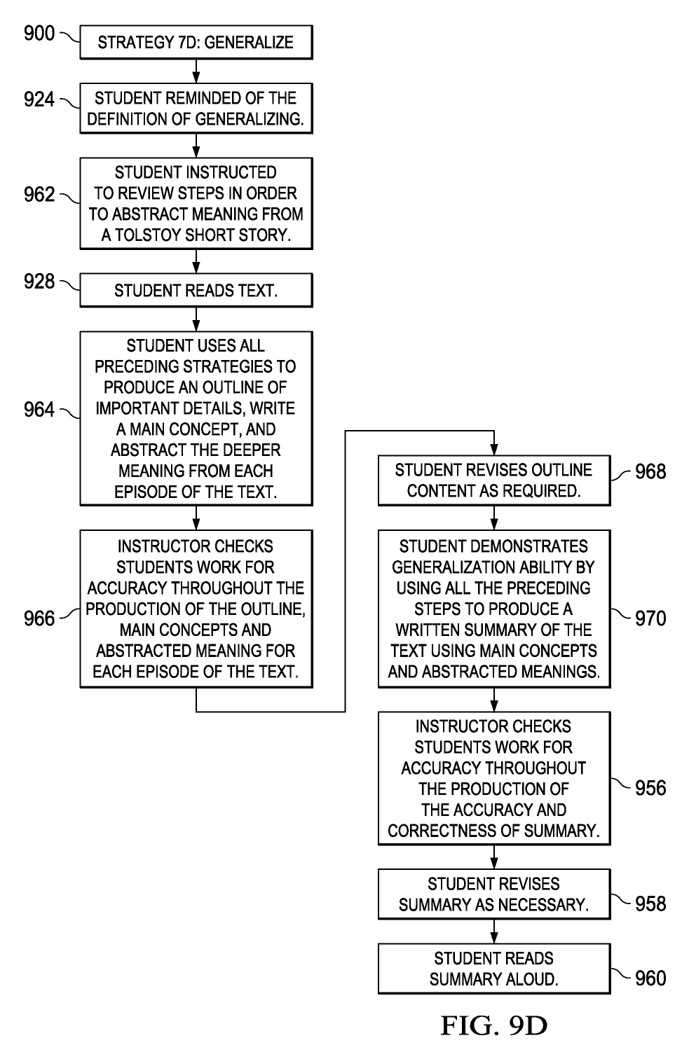

FIGS. 9A-9D provide a schematic outline of the different steps that are performed in the Generalize stage 900 of the training. The goal of this step is to summarize using supporting key points (zoom in); then generalizing to other contexts and situations and abstracted ideas with (zoom out). The subject using these steps learns to use the strategies to abstract meaning from texts by zooming in to focus on important details and organize the information into clear concise main concepts and gist-based abstracted meaning that formulate summaries. In FIG. 9A, the strategy is defined and explained to the subject in step 902. This is followed by a demonstration of the generalizing strategy through a short discourse passage that alludes to but does not directly state abstracted meanings (904). In step 906 a demonstration of using context clues and world knowledge to abstract meaning is performed. The subject then identifies statements that reflect main concepts and abstracted meanings at two different levels in step 908. In step 910 the subject demonstrates strategy ability by exhibiting recognition of main concepts and multiple abstracted meanings. Instructor review and subject revision if needed are performed in steps 912 and 914, respectively. In step 916 the subject demonstrates strategy ability by producing main concepts and multiple abstracted meanings by reducing complex material to its essence. In step 918 the instructor checks the subject's work for accuracy. The subject in step 920 revises the work as necessary to reflect understanding of basic and high-level abstracted statements. Finally in step 922, the instructor checks the subject's work for accuracy.

In FIG. 9B, the subject begins the generalization stage 900, by getting a reminder of the definition of generalizing in step 924. The instructor then instructs the subject to review strategies in order to abstract meaning from a narrative text (926). In steps 928 and 930 the subject reads the text and uses all the preceding strategies (300, 400, 500, 600, 700, and 800) in order to produce an outline of important details, main concept, and abstracted meaning from each episode. Steps 932 and 934 are instructor review and revision by the subject, respectively. In step 936 the subject demonstrates generalization ability by combining the main concepts and abstracted meanings to formulate a summary of the narrative. In step 938 the instructor reviews the subject's work for accuracy. In step 940 the subject revises the summary if required. In step 942 the subject reads the complete summary aloud.

FIG. 9C is an outline of generalization stage 900, which begins by the subject getting a reminder of the definition of generalizing in step 924. The instructor then asks the subject to review strategies and their contribution to abstracting meaning and everyday usage in step 944. In step 946 the subject practices abstracting meaning from a textbook passage provided by the instructor. The instructor then constructs questions regarding the expository text in step 948. Step 950 is a review step wherein the instructor checks the subject's work for accuracy throughout the production of the outline, main concepts, and abstracted meanings for each text topic. The subject then revises the answers to improve accuracy in step 952. In step 954 the subject uses all the preceding strategies (300, 400, 500, 600, 700, and 800) in order to produce main concepts, and abstracted meanings to produce a summary of the textbook passage. The instructor then checks the work for accuracy and completeness in step 956. The subject then revises the contents as necessary in step 958 and reads the summary aloud in step 960.

In FIG. 9D, the subject begins the generalization stage 900, by getting a reminder of the definition of generalizing in step 924. The subject is instructed to review steps in order to abstract meaning from a short story (for example a Tolstoy short story) in step 962. In step 928 the subject reads a text and uses all the preceding strategies (300, 400, 500, 600, 700, and 800) in order to write a main concept, and abstract the deeper meaning from each episode of the text (step 964). In step 966 the instructor checks the work for accuracy throughout the production of the outline, main concepts, and abstracted meanings for each episode. The subject revises the outline content as required in step 968. In step 970 the subject uses all the preceding strategies (300, 400, 500, 600, 700, and 800) in order to produce a written summary of the text using main concept and abstracted meanings. Instructor review (step 956) and subject revision if needed (step 958) are followed by step 960 of reading the summary aloud.

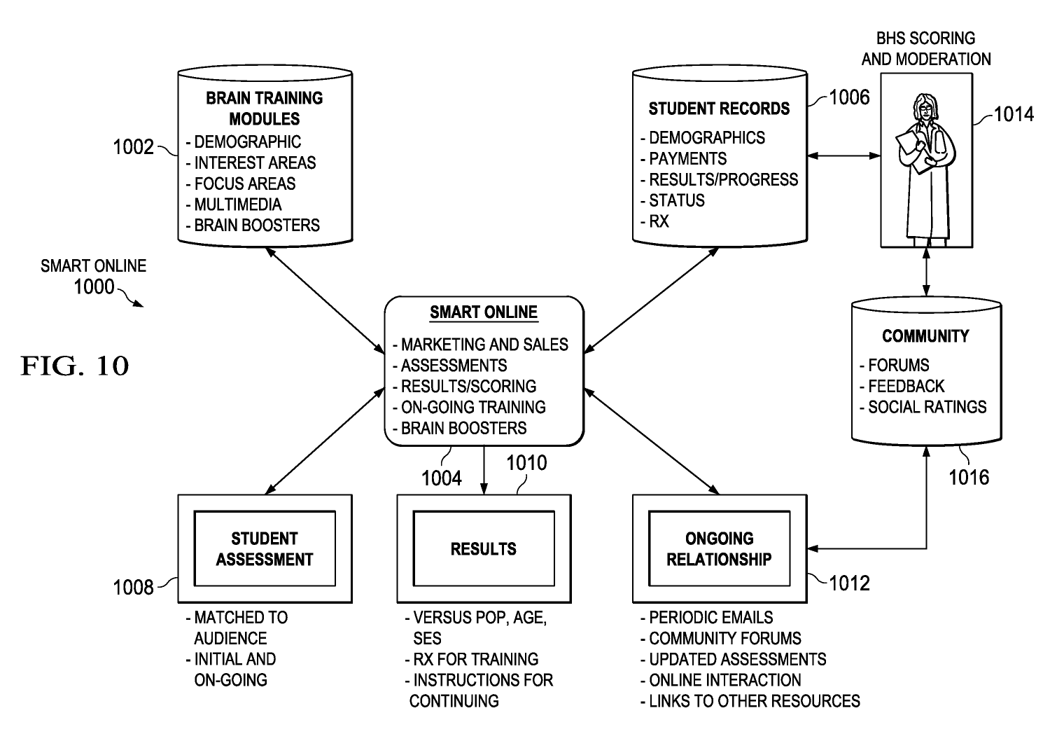

FIG. 10 is a schematic representation of the different modules of an online version of the SMART system 1000 and their inter-relationships. The main SMART online module 1004 receives inputs and provides output to multiple modules. The training module 1002, has the information on the test standard, the subject age, interest and focus areas along with various Brain Boosters and is in a two-way communication mode with the online module 1004. The online module 1004 has information on marketing/sales, has the tests sections, results/scores, training sections and Brain Boosters. Once the assessment is done the results are stored in a separate database/server/module 1010. Module 1004 also is in two-way communication with a subject assessment database/server/module 1008 that continually matches the results for a subject with previously stored results for a sample of subjects. The online module 1004 can also interact with a subject's records module 1006 that has pre-test information on subject demographics, previous test results, progress, status, study plan, etc. The online module 1004 receives information from the records module 1006 and also continually updates the information contained in the records module 1006.

A test administrator (or a teacher, a counselor, a therapist, a psychologist, etc.) 1014, access the information in the records module 1006 to monitor the progress of the subject, provide recommendations, counseling or devise a study plan for the subject. The administrator 1014 also gives and receives feedback from the community 1016 (comprising parents, school, teachers, doctors, etc.) regarding the progress of the subject. The administrator 1014 is not the only source of information for the community 1016, an ongoing relationship module/database 1012 built in the system 1000 continually provides feedback via periodic emails, updated assessments post testing, information and links to other resources, reminders for upcoming programs or tests, etc. The module 1012 is in two-way communication with the online module 1004.

### Smart Session 1: Bounce it

The brain learns best when unimportant facts are ignored and the important facts are remembered. The focus is on bouncing out unimportant details and keeping the important ones because deleting the unimportant details helps the subject to focus on what is important. Bounce out: Extra details and repeated Information. Focus on: main characters, important actions, and facts related to the topic

### Example 1

### Practice Activity: A Day at the Beach

| | | | |
|---|---|---|---|
| Saw | Flip Flops | Beach Ball | Coat |
| Tie | TV | Sunglasses | Couch |
| Swimsuit | Cooler | Calendar | Scarf and Mittens |
| Paper Clips | Surfboard | Sunscreen | Towel |

Directions are then provided to the subject to remove items that are not relevant, e.g., “First BOUNCE OUT all the items that one wouldn't use for a day at the beach. See what's left over then,” write the 3 most important items needed at the beach and why one needs them. The subject is then asked to list, for example, the 3 most important items.

### Example 2

### Dirk Nowitzki and the NBA Playoffs

Directions: Read this story twice. The first time, read it to understand the story, the second time use the bounce it strategies learnt today. Then cross through the sentences with a pen or pencil. Dirk Nowitzki is a basketball player. He plays for the Dallas Mavericks. He is originally from Germany. He is tall and has blond hair. Dirk helped the Mavericks go to the 2006 NBA Finals. The Mavericks played the Miami Heat. Miami is in Florida. Shaquille O'Neal is on the Miami Heat. Shaq is also tall. Dirk averaged 27 points per game in the playoffs. His favorite color is blue. The Mavericks won the first two games. The owner Mark Cuban thought the Mavericks would defeat the Heat. Some people believed the Mavericks were too sure of themselves. The Miami heat ended up winning the series 4-2. Shaq was happy. Even though the Mavericks did not win the playoffs, Dirk is still an amazing player in the NBA. Hopefully the Mavericks will make the playoffs again. When the subject BOUNCES OUT the unimportant information the important information pops out.

### Example 3

### The Rise of MTV and Its Influence on American Pop Culture

Directions: Read this story twice. The first time, read it to understand the story, the second time use the bounce it strategies learnt today. Then cross through the sentences with a pen or pencil. MTV (Music Television) is an American cable television network based in New York City. Launched on Aug. 1, 1981, the original purpose of the channel was to play music videos guided by on-air hosts known as VJ's. The term VJ (video jockey) was coined, a play on the acronym DJ (disc jockey). Many VJ's. eventually became celebrities in their own right. The original five MTV VJ's in 1981 were Nina Blackwood, Mark Goodman, Alan Hunter, J. J. Jackson and Martha Quinn. In 2005, this group (except for J. J. Jackson, who died in 2004) became hosts on Sirius Satellite Radio.

The early music videos that made up the bulk of MTV's programming in the 1980s were often crude promotional or concert clips from whatever sources could be found. As the popularity of the channel rose and record companies recognized the potential of the medium as a tool to gain recognition and publicity, they began to create increasingly elaborate clips specifically for the channel. Today, MTV still plays a limited selection of music videos, but the channel primarily broadcasts a variety of pop culture and reality television shows targeted at adolescents and young adults. MTV's choice to focus on non-music programming, such as The Real World, Road Rules, The Osbornes, and Punk'd, has been contested relentlessly since the 1990s, demonstrating the channel's impact on popular culture.

MTV has spawned numerous sister channels in the U.S. and affiliated channels internationally such as MTV2, MTV Tr3s, and numerous native-language MTV-branded music channels broadcast to dozens of countries around the world. MTV's moral influence on young people, including examples of censorship and social activism, has been a subject of debate for years. Before 1983, Michael Jackson struggled to get MTV airtime because he was a black artist. To resolve this struggle, the president of CBS Records at the time, Walter Yetnikoff, denounced MTV in a strong, profane statement, threatening to take away MTV's ability to play any of the record label's music videos. His harsh stance worked, and MTV began showing “Billie Jean” in regular rotation, forming a lengthy partnership with Jackson and helping other black music artists. More recently, MTV has introduced the social activism and awareness programs of Choose or Lose, Fight for your Rights, and Think MTV.

### Example 4

### The History of Africa

Directions: Read this story twice. The first time read it to understand the story, the second time use the bounce it strategies learnt today. Then cross through the sentences with a pen or pencil. Some of the first people are believed to have come from Africa. Scientists have found bones from the earliest people there. Africa is one of the largest continents on earth. Today the continent of Africa is divided into many countries. Today there are 47 different countries that make up the continent. The area known today as the Sahara Dessert used to be wet, fertile, grasslands. In fact, people raised cattle in the area that is now dessert. They lived and worked there until the climate began to change. Climate means the type of weather in the environment. Then about 7,000 years ago the climate in Africa changed dramatically. What was once a good area for raising cattle became dry, dessert land. Some people stayed in Africa but many others migrated to other parts of the world so they could live in moister climates. Moist climates mean that there is enough rain for plants to grow. Rain is important for animals as well because they need water to survive and to help grow the food they will eat. The people who stayed in Africa moved away from the Sahara to lands that had a moister climate. They didn't want to stay where it was too dry to farm and raise animals. Some people moved to the South of the Sahara, others moved northward to the Nile River Valley in Egypt. But the Sahara had few people left.

### Smart Session 2: Arrange it

The present inventors have found that the brain learns best when the information is arranged and organized. The session focuses on putting things in an order that makes sense, because it's easier to find things in the brain if they're organized.

### Example 5

### Little Red Riding Hood

Read the passage all the way through, bounce out the unimportant information, then arrange the passage into episodes and come up with a trigger word for each episode. Then, Read the outline to determine if anything important has been left out?

A few minutes later, Little Red Riding Hood knocked on the door. The wolf jumped into bed and pulled the covers over his nose. She came in and noticed that her grandma looked a little different. But the wolf disguised as grandma kept giving her excuses to try to fool her.

Little Red Riding Hood's mother told her to be careful in the woods and not to get distracted along the way. Little Red Riding Hood promised, but as soon as she got out into the woods and saw the beautiful flowers and felt the warm sun, she forgot.

The wolf, in the meantime, took a shortcut through the woods to Grandma's house and knocked on the door. Without so much as a peep, the wolf gobbled up grandma and let himself in before Little Red Riding Hood had arrived.

Little Red Riding Hood was so scared. She swore to her grandma that she would never talk to strangers again!

Once upon a time, there was a little girl who lived in a village near the forest. Whenever, she went out, the little girl wore a red riding coat, so everyone in the village called her Little Red Riding Hood.

Suddenly, a wolf sneaked up beside her and asked her what she was doing so far out in the woods. She said she was going to visit her grandma. Then Little Red Riding Hood realized she was late and ran quickly down the path.

One morning, Little Red Riding Hood asked her mother if she could go to visit her grandmother who lived in the forest. Her mother agreed so they packed a basket for Little Red Riding Hood to take to her grandmother and off she went in her red coat.

Suddenly the wolf had enough and jumped out of the bed trying to eat Little Red Riding Hood. Luckily she screamed so loud that a nearby woodsman heard her and ran towards the cottage. He made the wolf spit out poor Grandma. She was a bit frazzled, but ok. The wolf ran off into the woods

The subject is then asked to place put the story in order, e.g., the subject is asked to arrange the story in order. The subject may be asked, “Does this story make sense? Put the story in the correct order by placing the numerical order in the line provided.”

______ A few minutes later, Little Red Riding Hood knocked on the door. The wolf jumped into bed and pulled the covers over his nose. She came in and noticed that her grandma looked a little different. But the wolf disguised as grandma kept giving her excuses to try to fool her.

______ Little Red Riding Hood's mother told her to be careful in the woods and not to get distracted along the way. Little Red Riding Hood promised, but as soon as she got out into the woods and saw the beautiful flowers and felt the warm sun, she forgot.

______ The wolf, in the meantime, took a shortcut through the woods to Grandma's house and knocked on the door. Without so much as a peep, the wolf gobbled up grandma and let himself in before Little Red Riding Hood had arrived.

______ Little Red Riding Hood was so scared. She swore to her grandma that she would never talk to strangers again!

______ Once upon a time, there was a little girl who lived in a village near the forest. Whenever, she went out, the little girl wore a red riding coat, so everyone in the village called her Little Red Riding Hood.

______ Suddenly, a wolf sneaked up beside her and asked her what she was doing so far out in the woods. She said she was going to visit her grandma. Then Little Red Riding Hood realized she was late and ran quickly down the path.

______ One morning, Little Red Riding Hood asked her mother if she could go to visit her grandmother who lived in the forest. Her mother agreed so they packed a basket for Little Red Riding Hood to take to her grandmother and off she went in her red coat.

______ Suddenly the wolf had enough and jumped out of the bed trying to eat Little Red Riding Hood. Luckily she screamed so loud that a nearby woodsman heard her and ran towards the cottage. He made the wolf spit out poor Grandma. She was a bit frazzled, but ok. The wolf ran off into the woods

The subject will generally be asked to read the passage all the way through, bounce out the unimportant information, then arrange the passage into episodes and come up with a trigger word for each episode. For example, the subject will be prompted to “Then, Read your outline. Ask yourself ‘Did I leave anything important out?”

### Smart Session 3: Uncover it

The brain learns best when the subject understands the hidden meaning. The focus of the session is to use inferencing to understand the full meaning of information by using clues to figure out the meanings of words or sayings and to find the deeper meaning because filling in the missing pieces helps in the understanding of the complete “story.”

### Example 6

### Uncovering Meaning of Unknown Words

1. The tall model may be aesthetically appealing, but her attitude is less than beautiful. What does the word “aesthetically” mean?

2. David thought he was being surreptitious when he slowly took the candy bar from the aisle and put it in his pocket, but the store's video cameras caught him on tape. What does the word “surreptitious” mean?

3. Patrick doubted the clairvoyant abilities of the fortuneteller, especially after she told him he would move to Thailand next year. What does the word “clairvoyant” mean?

### Example 7

### Uncover the Meaning

The subject is instructed to read each dialogue, to think about what the person is saying, and use the clues to uncover the meaning

1. “Albert, it's been very interesting working with you over the past month,” observed Ms. Flores. “However, your working style and our company's policies differ greatly. Therefore, we have decided to request that you resign immediately. What was Ms. Flores telling Albert?

a. She would be upset if he quit.
b. He was getting a pay raise.
c. He was being fired.
d. She really enjoyed working with him.

2. Mrs. Breen said to her husband, “You know dear, I really don't need you to buy me an expensive birthday gift this year. Having a wonderful husband like you is a gift in itself. In fact, I'll just drive my rusty rattletrap over to the store and buy myself something new. And if that old jalopy doesn't break down on the way, I'll be back before you know it.” What does Mrs. Breen really mean?

a. I'll carry a bucket for you.
b. I don't want a gift.
c. Buy me a new car.
d. I like shopping by myself.

3. Jessica and her class were playing kick ball during P.E. Jessica and her friend Jill always volunteered to play outfield where few balls actually went. We can infer that:

a. Jessica and Jill are not very good players.
b. Jessica and Jill wanted to be active players.
c. Jessica and Jill were the best players on their team.
d. Jessica and Jill wanted to talk and braid each other's hair.

### Example 8

### Uncover Meanings of Sayings

Directions: Figure out the meaning of the sayings in each group of sentences.

1. Mrs. Smith wanted to take her art class on a field trip to a museum for a special exhibit of Picasso's work. The principal thought it was too far to go and too expensive. He thought Mrs. Smith should teach the class about Picasso's work in the classroom. Mrs. Smith argued, “A journey of a thousand miles is better than studying a thousand books.” What did Mrs. Smith mean?

2. Jason was always getting in trouble for talking during class. He was sure his teacher just didn't like him. He went home with another detention slip and told his parents he wanted to switch teachers. His dad said, “A cow which is dragged to Beijing is still a cow.” What did his dad mean?

Sometimes the subject does not know exact meaning of a word or may not know exactly what the underlying message is. To help better understand the subject is taught to look for clues and think about the situation and the characters' possible motives. To analyze a situation the subject is told to think about the time period, people's relationships, their actions, and their goals. This will help in understanding the message conveyed by the text.

The subject is instructed to read the next story out loud. As he/she reads, they are instructed to think about the underlying message by analyzing the situation and the characters' possible motives. Finally to uncover the unstated meanings the subject is told to answer the questions after reading.

### Example 9

### The Guardian Angel

Early one hot July morning, Edgar G. Grimes got up and instead of having a leisurely breakfast, he gulped down a quick cup of coffee. He explained to his wife that he had an important breakfast meeting at work as he rushed out the door. Edgar did not go to a meeting at work but instead drove his 15 year old Cadillac to a travel agency and bought a one way ticket to Tahiti under the name Samuel Price. After purchasing the ticket, he drove directly to the shoe store where he had worked since finishing high school. He was the manager of the store and was in charge of opening and closing the doors every day.

When he arrived at the store, his boss, Mr. Foster, met him at the door and congratulated him on his retirement. Mr. Foster was dressed in his usual khaki pants, white button down shirt, and a tie. Mr. Foster told Edgar that he was very sorry that Edgar would not get more money from the company retirement fund, but times were tough and it was the best the company could do. Edgar thanked Mr. Foster and smiled to himself because he wasn't really worried about money.

As the manager of the shoe store Edgar had been in charge of making nightly bank deposits. About 38 years ago, not long after he was promoted to manager, Edgar noticed a loose brick in the wall next to the desk. When he pulled the brick out, Edgar discovered an empty space in the wall behind the brick. From that day on, Edgar started putting a $50 bill behind the brick when he prepared the store's nightly bank deposit. Today was the day he planned to get the money out the hiding place when all the other employees had gone home. He knew that he would have almost one million dollars saved. Although it was the store's money, he felt he deserved it because he worked hard.

Fifteen minutes before closing time, friendly Mrs. Trotter from the cookie store came in to buy a new pair of shoes. Mrs. Trotter had white powder in her hair and smelled like cinnamon. Her store was next door to the shoe store and the sweet smell of cookies often made Edgar hungry. She chatted happily as she tried on three different pairs of shoes, hoping to find the right ones to wear to her niece's wedding Edgar wanted her to choose quickly so that he could close up the store and be on his way. As he helped her try on the shoes, she began to tell him the story of her guardian angel.

Mrs. Trotter told Edgar that many years ago she thought she would have to go out of business because she couldn't afford to pay the rent for her shop. To keep her mind off her troubles, she got down on her hands and knees and started scrubbing the floor underneath the cabinet on the wall. It was a tiny space and her hand barely fit, but to her amazement she found the rent money under there. She was relieved and certain that her guardian angel left it for her to find! Edgar nodded and smiled patiently.

Then Mrs. Trotter told Edgar that she continued to find money in the same tiny space every single night! She told him that she had bought her husband a new wheelchair and was able to help send her grandchildren to college with the money. All of a sudden, Edgar blurted out, “Did you say you found money every night? How much did you find?” His face started to turn red and he began to feel sweat pouring down the back of his neck. “A crisp $50 bill” replied Mrs. Trotter, “left by my angel.”

1. The fact that Edgar bought a one-way ticket to Tahiti instead of a round-trip ticket suggests what?

2. Why did Edgar tell the travel agent his name was Samuel Price?

3. Do you think that Mrs. Trotter will:

a. Continue to find a $50 bill every day
b. Stop shopping at the same shoe store
c. Wonder what happened to her “guardian angel”
d. Not receive any more money from her “angel”

4. What will Edgar discover when he looks for the money he stored? What might he do now?

5. How do you think Edgar feels at the end of the story?

6. What lesson did Edgar learn from this?

### Smart Session 4: Customize it

The brain learns best when information the subject puts the information in their own words. The focus of the session is to encouraged to put information in their own words because it's easier to learn and remember when one uses one's own words or in their own way.

SMART Customize it Scoring System:

The following point system can be used to score the subject's responses:

0 points—if the subject only bounce a few words;
1 point—if the subject rearranges the order but keep most of same words;
OR
   1 point—if the subject adds a few new words but most of the words are the same;
   2 points—if the subject keeps the idea the same but most of the words are changed

### Example 10

The movie Harry Potter is very popular because Harry is a wizard. Children like the books and love the movies.

0 point customized sentence: The movie Harry Potter is popular because Harry is a wizard. Children like the books and love the movies.

1 point customized sentence: Children like the Harry Potter books and love the movies because Harry is a wizard.

2 point customized sentence: Many people like the Harry Potter books and movies because they're about kids who can do magic.

### Example 11

The following point system can be used to score the subject's responses: 2 points—if the subject kept the same idea but changed most of the words, 1 point—if the subject rearranged the order or added/changed some words BUT kept most of the same words, 0 points—if the subject bounced only a few words. Next, the subject is asked to Score these customized sentences:

1. The children were excited to see the funny clown. They laughed and laughed at his jokes. The subject is then asked to answer the following:

a. The children were excited to see the clown. They laughed at his jokes. ______;
b. The kids were glad to see the funny clown and they laughed at his jokes. ______; and
c. The kids thought the clown's jokes were hilarious. ______.

2. Janie's mom was upset because their cat was stuck in a tree. The tree was as tall as the house. The subject is then asked to answer the following:

a. Janie's mom was upset because their cat was stuck in a tree as tall as the house. ______;
b. When the family's cat climbed too far up the humongous tree, Janie's mom began to cry. ______; and
c. The family cat couldn't climb down from the huge tree and Janie's mom was frantic. ______.

### Example 12

The following point system can be used to score the subject's responses: 2 points—if the subject kept the same idea but changed most of the words, 1 point—if the subject rearranged the order or added/changed some words BUT kept most of the same words, 0 points—if the subject bounced only a few words. Next, the subject is asked to Score these customized sentences:

1. The boys at my school play a lot of sports. They practice after school. The subject is then asked to answer the following:

a. Many boys are athletes at my school and they practice after school. ______;
b. The boys at my school play sports. They practice after school. ______; and
c. Lots of the guys are busy after school going to sports practice. ______

2. Sam taught his dog to sit, beg and fetch. He gives the dog treats. The subject is then asked to answer the following:

a. Sam gives his dog treats for sitting, begging and fetching. ______;
b. Sam's dog is very smart and learned to do tricks for treats. ______; and
c. Sam trained his dog to do many tricks using treats as rewards. ______.

### Example 13

The subject is asked to: 1. Read the sentences; 2. Cover the sentences up; 3. Think about what they read and what is the meaning; 4. Write a complete and high level (2-point) customized sentence; and 5. Re-read the original sentences, re-read the customized sentence, give themselves the appropriate score. Scoring the customized sentences helps the subject check how well he/she has done.

The subject is asked to customize the following sentences to try to make 2 points. The following scoring system can be used: 2 points—if you keep the same idea but changed most of the words; 1 point—if you rearranged the order or added/changed some words BUT kept most of the same words; 0 points—if you bounced only a few words.

1. Alex feeds her gerbil dried fruit, peanuts and sunflower seeds every day after school. She also gives him fresh water. The subject is then asked to determine their score.

2. Lindsey's friends like to play hide-and-go-seek and tag. Her brother Rob likes to play video games and air hockey with his friends. The subject is then asked to determine their score.

3. Every day someone in America decides to show kindness towards another person. The other person could be in the same city or in another part of the world. When someone is treated with kindness, there is often a domino effect; the kind act multiplies with each new person who is affected. The subject is then asked to determine their score.

### Example 14

### Dallas a New Beginning

John Neely Bryan, while looking for a new place to start a trading post, explored the area now known as Dallas, Tex. in 1839. Bryan thought the area where the Trinity River was shallow and narrow appeared to be ideal. Native American tribes lived close by and although embracing Native Americans was largely unpopular at the time, Bryan followed in Sam Houston's footsteps by respecting and embracing them. He thought they would be a ready-made customer base. Additionally, the Preston Trail, the newly designed passage connecting south Texas with the rest of the country, was slated to go directly through the area. The physical attributes of the land and the planned trail made the area ideal for a successful trading post.

After scouting out the area in Texas, John Neely Bryan returned to Arkansas to get his affairs in order before making the move. His trading post in Arkansas was marred by a poor economy, so he severed all ties to his business in order to move completely to Texas. However, during that time, a lot was changing in Texas. In 1839, The Cherokee War, the war between the Republic of Texas and the Cherokee Nation, was fought and won by the Texans, resulting in the Treaty of New Echota. This treaty effectively removed all Native Americans from North Texas, reducing possible customers for Bryan's trading post. When Bryan returned to Texas, he decided to make the area into a permanent settlement instead of merely a temporary trading post. Bryan invited the residents of the nearby settlements to come live in his newly founded city. With the influx of new residents to the city, Bryan was single-handedly responsible for the day-to-day operations. He held almost every job in town from ferry operator to post master to store owner. His home was even the official courthouse for a time. His city was eventually named Dallas after the Vice President of the United States George Mifflin Dallas. In 1845, the first election was held in Dallas; the issue: whether Texas should be annexed into the United States of America. Of the 32 citizens eligible to vote, 29 voted for annexation and 3 voted against.

In 1855, a group of French socialists attempted to develop a utopian community west of Dallas called “La Reunion.” A mix of European artists and writers joined the community. This experimental city flourished for a while, but the Europeans were not expecting the severe Texas weather. In 1857, a blizzard hit their farmlands in the winter, then an extreme heat wave and drought hit in the summer The crops were decimated and the discouraged settlers moved to Dallas. This creative group set up a base of cultural and artistic influences, which can still be seen today in Dallas neighborhoods known today as Deep Ellum and Lower Greenville Ave.

Steps to “Customize It!”: The subject is asked to: 1. Read the sentences; 2. Cover the sentences up; 3. Think about what they read and what is the meaning; 4. Write a complete and high level (2-point) customized sentence; and 5. Re-read the original sentences, re-read the customized sentence, give themselves the appropriate score. These sections are them customized into 2-point customizations and the sentences rated.

1. After scouting out the area in Texas, John Neely Bryan returned to his native Arkansas to get his affairs in order before making the move to Texas. His trading post in Arkansas had been marred by a poor economy, so he had little difficulty severing his business ties there.

2. Bryan invited the residents of the nearby settlements to come live in his newly founded city. With the influx of new residents to the city, Bryan was single-handedly responsible for the day-to-day operations. He held almost every job in town from ferry operator to post master to store owner.

3. In 1845, the first election was held in Dallas; the issue: whether Texas should be annexed into the United States of America. Of the 32 citizens eligible to vote, 29 voted for annexation and 3 voted against.

4. In 1855, a group of French socialists attempted to develop a utopian community west of Dallas called “La Reunion.” A mix of European artists and writers joined the community This experimental city flourished for a while, but the Europeans were not expecting the severe Texas weather. In 1857, a blizzard hit their farmlands in the winter, then an extreme heat wave and drought hit in the summer The crops were decimated and the discouraged settlers moved to Dallas. This creative group set up a base of culture and artistic influences, which can still be seen today in Dallas neighborhoods known as Deep Ellum and Lower Greenville Avenue.

The following scoring system can be used: 2 points—if you kept the same idea but changed most of the words; 1 point—if you rearranged the order or added/changed some words BUT kept most of the same words; 0 points—if you bounced only a few words

### Smart Session 5: Link it

The brain learns best when the information is linked together. The focus of the session is to join similar information together into a main concept because it's easier to learn when you link pieces of information together. The Main Concept of an episode or topic is a sentence (or two) that collapses the important information succinctly. The frontal lobes take details from the parietal lobes to store them more efficiently when information is synthesized

A Main Concept of an episode or topic is a sentence (or two) that links the important information succinctly.

### Example 15

### Linking A List

1. Judy bought milk, sour cream, ice cream, cheese, yogurt, pudding, butter, cottage cheese, frozen yogurt, cheesecake, and whipped cream.

2. The kids got off the school bus carrying trumpets, tubas, drums, saxophones, clarinets, cymbals, and flutes.

Link It Scoring System: 0=not a complete sentence or more like trigger words; 1=contains part of the important information but is vague; 2=contains enough information to provide a clear understanding of the important details.

### Example 16

### Soccer Players

Four friends decided to look for information to help them become better soccer players. Mary decided to go to the library, while Sam went to the bookstore. Suzy looked up information on the internet and Tom talked to the coach.

Finding information about soccer. Score ______

The friends wanted to learn about soccer. Score ______

The four friends decided to use research from different sources to learn more about soccer. Score: ______

### Example 17

The subject is asked to read each group of sentences twice. The second time is silent read to oneself. Ask yourself what is the main concept? (Who is this about? What is that person doing?) How can you customize the main concept clearly? The subject is then asked to link the following sentences into complete and clear main concepts, to then score the sentences to make sure that the subject is linking the information as well as the administrator. The subject is asked to try to make each of your sentences worthy of a 2.

1. Judy's favorite class is English. Her brother Bill likes math the best. Their sister Alice likes science and P.E. Their sister Susie's favorite subject is geography. Their brother Sam likes reading. Link the sentences into one complete and clear main concept and score your result.

2. Baseball season starts in the spring and goes through summer On the other hand, football is a fall sport, as is soccer. Basketball and hockey are played during the winter months. Volleyball is played in the late summer and early fall. Link the sentences into one complete and clear main concept and score your result.

3. Ted and his dad wanted to go camping. Ted put the sleeping bags and backpacks in the car. He also packed the first aid kit and the tent. Ted and his dad went to the store to pick up some snacks and other food before they left town. They made sure they had water to drink and matches for starting a campfire. Link the sentences into one complete and clear main concept and score your result.

### Plan It!!!

### Example 18

### Spitz vs. Phelps: Swimming Phenomena

In 1968, at the age of 18, Mark Spitz bragged that he would win 6 gold medals at the Olympics in Mexico City. He had only been swimming at the international level for 3 years, but was convinced he could win 6 gold medals. At that Olympics, Spitz only won 2, and both were group races. Spitz was extremely disappointed, but spent the next four years training at Indiana University with the famous swim coach Don Counsilman. The next Olympics was held in Munich, Germany. There, Spitz redeemed himself by winning 7 gold medals. For the next 35 years, no one came close to getting more gold medals at a single Olympics than Mark Spitz.

Then along came Michael Phelps. At age seven, Phelps was diagnosed with severe ADHD. His mother noticed how much he loved to swim, so she had him begin taking competitive swimming lessons; swimming provided an outlet for his hyperactivity.

By the time he was 15, Michael Phelps swam in his first Olympics. That was 2004 and he won 6 gold medals, losing one of his races to Australian swimmer Ian Thorpe. Thorpe retired after that Olympics and said that Phelps could never surpass Spitz's record of 7 gold medals. Phelps used this comment as motivation to work even harder for the 2008 Beijing Olympics.

During the 2008 Olympics, in a dramatic display of athleticism, Phelps won 8 gold medals, beating Spitz's record. Now it is Michael Phelps who owns the record for the most gold medals won at a single Olympics game.

Even Mark Spitz took notice. After the Olympics, Spitz commented on Phelps's amazing performance saying, “It goes to show you that not only is this guy the greatest swimmer of all time and the greatest Olympian of all time, he's maybe the greatest athlete of all time. He's the greatest racer who ever walked the planet.”

The subject is asked to “Bounce” the unimportant information, “Arrange” the episodes, “Uncover” the hidden meanings, “Customize” and “Link” the important details into MAIN CONCEPTS for each episode. The subject is then asked to score his/her main concepts.

The scoring system comprises: 0=not a complete sentence or more like trigger words; 1=contains part of the important information but is vague; 2=contains enough information to provide a clear understanding of the important details.

### Example 19

### The Emperor's Seeds

Directions: Read the story. Bounce unimportant details, then arrange the uncovered and customized details. Link the important details into high-level main concepts. Score your main concepts. After you write and score your main concepts, link the main concepts together into a summary.

An emperor in the Far East was growing old and knew it was time to choose his successor. An emperor is a king. Instead of choosing one of his assistants or his own children, he decided to do something different. He called all the children in the kingdom together. He said, “It is time for me to choose the next emperor and step down. I have decided to choose one of you.”

The children were shocked! The emperor continued, “Today, I am going to give each one of you a very special seed. I want you to plant the seed, water it, and come back here in one year. When you come back you will show me what you have grown from this one seed. I will judge the plants that you bring, and choose who will be the next emperor!”

One boy named Ling was there that day and he, like the others, received a seed. He went home and excitedly told his mother the story. She helped him get a pot and planting soil. He planted the seed and watered it carefully. Every day he watered it and watched to see if it had grown.

After about three weeks, some of the other children began to talk about their seeds and the plants that were beginning to grow. Ling kept checking his seed, but nothing grew. Three weeks, four weeks, five weeks went by. But Ling had no plant growing from his seed.

Six months went by but there was still nothing in Ling's pot. By now, the other children were all talking about their plants. Ling didn't have a plant, and he felt like a failure. Ling was afraid he had killed his seed. All the other children had trees and tall plants, but he had nothing. Ling didn't say anything to his friends. He just kept waiting for his seed to grow. Every day he watered it and waited patiently.

A year went by and it was time for the emperor's inspection. All the children of the kingdom were told to bring their plants to the palace. Ling told his mother that he wasn't going to go because his seed had not grown. His mother told him to be honest about what happened. Ling felt sick to his stomach, but he knew his mother was right. He took his pot to the palace.

When Ling arrived at the palace, he was amazed at the variety of plants grown by the other children. They were beautiful and in all shapes and sizes. Ling put his empty pot on the floor. Many of the other kinds laughed at him. A few felt sorry for him and just said, “Hey, nice try.”

The emperor came in and surveyed the room. He greeted the young people. Ling tried to hide in the back. “My, what great plants you have grown,” said the emperor. “Today, I will appoint one of you the next emperor!”

All of a sudden, the emperor spotted Ling at the back of the room with his empty pot. He ordered his guards to bring him to the front. Ling was terrified. He thought, “The emperor knows I'm a failure! Maybe he will have me killed!”

When Ling got to the front, the Emperor asked his name. “My name is Ling,” he replied. All the children laughed and made fun of him. The emperor told everyone to quiet down. He looked at Ling, and then announced to the crowd, “Behold your new emperor! His name is Ling!” Ling couldn't believe it. Ling couldn't even grow his seed. How could he be the new emperor?

The emperor told the children that the seeds he had given them the year before were boiled. Boiled seeds do not grow. The emperor knew that Ling was honest and brave. Ling became the new emperor.

The subject is asked to “Uncover” the hidden meanings, “Customize” and “Link” the important information with the “Main Concepts” for each episode and score his/her main concept using the following scoring scheme: 0=if your main concept is no more than a word or two that are more like trigger words; 1=if your main concept contains part of the important information but is vague; 2=if your main concept contains enough information to provide a clear understanding of the important details.

### Smart Session 6: Flex it

The subject is encouraged to find a lesson, moral or a take home message. The brain learns best when what is already known is used to understand and remember new information. Using known facts enables deeper understanding of new facts. The strategy of the session is to use knowledge about a subject to help figure out new information. (What lesson can you learn or what is the ‘take-home message’?) because understanding the deeper meaning or lesson helps in the understanding and remembering of new information.

Lesson Statement Scoring System: Good lesson statements, (i) are transformed (not directly about characters in the story), (ii) interpret the entire story, not just one part, and (iii) are clear and concise.

Scoring the transformed lessons:

0=Does not pertain to the story or is not transformed
1=Pertains to only a part of the story and is not concise or is too general
2=Transformed, pertains to the entire story, and is concise

Scoring helps the subject to check how well he or she is doing.

### Example 20

### Lesson Statements for Little Red Riding Hood

0 points: Red Riding Hood should have listened to her mom. Why is this lesson 0 points?______

1 point: It is nice to go to see sick relatives because it makes you feel happy and they feel happy as well even if it's kind of scary and you'd rather stay at home baking cookies with your mom. Why is this lesson 1 point? ______

1 point: Beware of danger. Why is this lesson 1 point? ______

2 points: Good deeds triumph over evil intentions. Why is this a 2 point lesson? ______

Who's perspective does this lesson take? ______

2 points: Greediness can be your downfall. Why is this a 2 point lesson? ______

Who's perspective does this lesson take? ______

### Example 21

### The Three Bears

A family of three bears lived in a quiet house in the woods. One day, waiting for their porridge to cool, they left the house unlocked to go for a walk in the woods. While they were out, Goldilocks came across the house. Curious, she entered and meddled with the bears' belongings, sampling their porridge, sitting on their chairs, and then trying out their beds. She ended up falling asleep in the baby's bed. Goldilocks was still asleep in the baby's bed when the bears returned home. They woke her up and scared her away.

What's a lesson the subject can learn from this story? The points may be scored as follows: 0=Does not pertain to the story or is not transformed; 1=Pertains to only a part of the story and is not concise or is too general; 2=Transformed, pertains to the entire story, and is concise. Some examples of lessons from the story are:

| | |
|---|---|
| a. Don't eat other people's food. | Score |
| b. Goldilocks should have respected the bears' privacy. | Score |
| c. You should respect the privacy of others. | Score |
| d. You should ask permission before you touch other's | Score |
| belongings. | |

### Example 22

### Three Little Pigs

Mother Pig sent her three pigs out into the world. The first little pig was in a big hurry to get his house built first, so he used straw. A hungry wolf lived in the nearby forest. When he knocked on the door of the pig's house, the pig refused to let him in. The wolf became angry and blew the house down. The first pig ran to the second pig's house.

The second pig was also in a hurry to build his house so he built it out of sticks. The wolf successfully blew down the second pig's house as well, and the two brothers ran to the third brother's house.

The third pig had taken the time to build a strong house, he used bricks. The wolf could not huff and puff hard enough to blow the house down. He attempted to trick the third little pig out of his house, but the pig outsmarted him at every turn. Finally, the wolf threatened to come down the chimney, and plunged into a boiling pot of water.

What's a lesson the subject can learn from this story? The points may be scored as follows: 0=Does not pertain to the story or is not transformed; 1=Pertains to only a part of the story and is not concise or is too general; 2=Transformed, pertains to the entire story, and is concise. Some examples of lessons from the story are:

| | |
|---|---|
| a. Don't boil water in the fireplace. | Score |
| b. Take the time to do a good job. | Score |
| c. The first two pigs should have spent more time building | Score |
| their houses | |
| d. Your family will always protect you. | Score |

### Example 23

### Diamond in the Ruff

There was a neighborhood pet store that was struggling to stay open because business was slow due to the recession. The owner, Mr. Brown, had a dog that was a champion Dalmatian named Dotty. Dotty recently had a litter of purebred puppies and if Mr. Brown sold the puppies, he could make enough money to keep his shop open for the rest of the year. He put a sign in his storefront window advertising the champion pups.

A girl named Keisha was walking by the shop after school when she spotted the sign in the window and excitedly went into the store. She told Mr. Brown, “My mom said I could buy a puppy if I pay for it myself. I've been saving my money for three months. How much do the puppies cost?” Mr. Brown replied, “Probably more than what you have. These dogs are expensive and besides, they still need their mother for 2 more weeks.” Keisha tried to hide the tears that began to form in her eyes. Mr. Brown felt bad and grudgingly told her that she could look at the puppies if she came back in 2 weeks.

Exactly two weeks later, Keisha returned to the store and asked the Mr. Brown if she could see the puppies. Surprised that she had remembered, Mr. Brown felt obligated to show her the pups. He whistled loudly, and all but one of the pups looked up and scampered to the front of the store. Keisha smiled at the sight of the cute puppies, then she noticed that one tiny puppy was still sleeping peacefully in the dog bed. Suddenly, a box fell from one of the shelves. The puppies jumped and started barking loudly, but the little puppy in the bed didn't even flinch.

Keisha went over to the bed and spoke to the puppy to wake him up, when he didn't stir, she reached out to touch him. Upon her gentle touch, the puppy looked up at her and began to wag his tail. Keisha looked up at Mr. Brown and said, “This is the puppy I want! I have $20 saved and can pay you the rest when I get it.” Mr. Brown shook his head and told her, “You don't want to spend your money on that puppy; he's not as good as the others. He won't come to you when you call him.”

Keisha looked up at the store owner intently and pushed her hair behind her ears, revealing the hearing aids she had worn since she was three. “I think this puppy needs someone who can understand him and talk to him with more than words, I know how he feels and I can help him!”

The subject is provided with episodes of the “Arranged” and the subject is asked to “Bounce” it in his/her head, Uncover, Customize, and Link the important information to complete MAIN CONCEPTS; then Flex his/her understanding by giving a LESSON and CONCLUSION to the story.

Episode 1: There was a neighborhood pet store that was struggling to stay open because business was slow due to the recession. The owner, Mr. Brown, had a dog that was a champion Dalmatian named Dotty. Dotty recently had a litter of purebred puppies and if Mr. Brown sold the puppies, he could make enough money to keep his shop open for the rest of the year. He put a sign in his storefront window advertising the champion pups.

A girl named Keisha was walking by the shop after school when she spotted the sign in the window and excitedly went into the store. She told Mr. Brown, “My mom said I could buy a puppy if I pay for it myself. I've been saving my money for three months. How much do the puppies cost?” Mr. Brown replied, “Probably more than what you have. These dogs are expensive and besides, they still need their mother for 2 more weeks.” Keisha tried to hide the tears that began to form in her eyes. Mr. Brown felt bad and grudgingly told her that she could look at the puppies if she came back in 2 weeks.

Episode 1: Trigger Word: ______

1. ______

2. ______

3. ______

4. ______

Main

Concept:

My Score:

The scoring system described hereinabove for episode 1 is used throughout for all the following episodes of the story.

Episode 2: Exactly two weeks later, Keisha returned to the store and asked the Mr. Brown if she could see the puppies. Surprised that she had remembered, Mr. Brown felt obligated to show her the pups. He whistled loudly, and all but one of the pups looked up and scampered to the front of the store. Keisha smiled at the sight of the cute puppies, then she noticed that one tiny puppy was still sleeping peacefully in the dog bed. Suddenly, a box fell from one of the shelves. The puppies jumped and started barking loudly, but the little puppy in the bed didn't even flinch.

Keisha went over to the bed and spoke to the puppy to wake him up, when he didn't stir, she reached out to touch him. Upon her gentle touch, the puppy looked up at her and began to wag his tail. Keisha looked up at Mr. Brown and said, “This is the puppy I want! I have $20 saved and can pay you the rest when I get it.” Mr. Brown shook his head and told her, “You don't want to spend your money on that puppy; he's not as good as the others. He won't come to you when you call him.”

Episode 3: Keisha looked up at the store owner intently and pushed her hair behind her ears, revealing the hearing aids she had worn since she was three. “I think this puppy needs someone who can understand him and talk to him with more than words, I know how he feels and I can help him!”

The subject is now asked to answer the questions and Flex it! to provide lessons one learn from the story.

1. How did the store owner feel at the end of the story? ______

2. How did Keisha feel at the end of the story? ______

3. What are two lessons we can learn from Diamond in the Ruff?______

My Score ______

### Smart Session 7: Step it Up

The brain learns best when the understanding is stepped up to a higher level. The session focuses on zooming in and zooming out to help see the forest instead of just the trees by using the important information from knowledge to figure out the essence, spirit or gist. Stepping it up helps the subject use the frontal lobes to show knowledge. Getting the gist helps us concisely reduce complex material to its absolute essence.

Gist is (i) the central meaning or theme of a speech or literary work, (ii) the choicest, most essential or most vital part of some idea or experience, and (iii) the most essential part; the main idea or substance of a longer or more complicated matter

To understand the gist of something one needs to: understand and interpret the most important details (Bounce, Arrange, and Uncover it); reassess your interpretation (Ask oneself, is that correct or have I misinterpreted?); customize a main concept (Customize & Link), and step it up to express the bigger unstated ideas.

There are two levels of gist to formulate: 1. Basic gist—the generalized big picture and 2. High-level gist—the big picture combined with a lesson the character learned, a prediction of the future or the deeper motives/feelings of a character.

One could formulate the gist by taking the important information and using one's frontal lobes to combine it with what one knows from past experiences. Gist helps us understand the deepest meaning or what is implied but not directly stated. Thinking about the gist will make information more interesting and us smarter

### Example 24

### Tom's Essay

Tom forgot to write his essay, again. He politely asked his teacher if he could turn it in late. “Oh, sure,” said Ms. Jones sarcastically, “I know how hard you worked to get it here on time.” Tom walked away dejected and angry at himself.

What is the gist of this passage?

a. Ms. Jones is happy to accept late work. (incorrect—why?)
b. Tom forgot to do his homework and the teacher is annoyed. (main concept—why?)
c. Although Tom is embarrassed, his teacher has heard his excuses too many times to accept late work again. (Basic gist—why?)
d. Tom hasn't been dependable about turning his work in on time, pushing his teacher to the brink of anger, and he realizes that he had better change his ways or he will end up repeating the class. (High-level gist—why?)

### Example 25

### Emily and Sara

On Tuesday night Emily was hanging out with her best friend Sara, when she noticed that it was already 10:00 pm. Her curfew was 10:00 on a school night, however, the girls were having a great time IM'ing the boys in their class on Sara's laptop. Emily called her mom and her mom gave her 10 more minutes to get home. Instead of leaving immediately, Emily decided to stay for 10 more minutes. Suddenly it was 11:00 pm and she knew that she'd be up until 1:00 am with the lecture she was sure to get. She left Sara's house feeling anxious and remorseful.

Read all the statements then Rate them as: incorrect interpretation; main concept; simple gist; and high-level gist.

a. Emily was out past her curfew and she knew her mom would give her a lecture. ______

b. Although she had a lot of fun when she stayed out late, Emily knew her mom would be upset and it would be a long time before her mom would trust her judgment again, thus the fun came at a higher price than it was worth. ______

c. Emily thought her mom would not mind if she was late because she had called earlier. ______

d. When Emily realized how far beyond her curfew it was, she knew that she would have to pay the consequences for her irresponsible behavior. ______

e. Emily stayed at her friend's house chatting on the computer when she was supposed to be going home. ______

### Example 26

### Juan and Chloe

Juan was in the school library looking for a good book to help him finish his history report when Chloe, one of the most popular girls in school, came over and sat down beside him. Juan had known Chloe since 4th grade but they weren't really good friends. She smiled at him and quietly said, “Hi.” Juan smiled back and Chloe asked him if she could borrow his cell phone to send a text to Robert, her boyfriend. Just as he pulled his iPhone out of his pocket he noticed she had the answers to the science test in her hand. It dawned on him that during first period he overheard Robert talking about getting grounded next weekend if he didn't pass his science test that day, and next weekend was prom. Also, he saw Chloe use her phone during lunch. Juan put two and two together and realized he was being duped. He looked at his phone and told Chloe that his battery was dead. Chloe rolled her eyes and left the library.

Read all the statements then Rate them as: incorrect interpretation; main concept; simple gist or high-level gist.

a. Chloe tried unsuccessfully to trick Juan into helping Robert cheat on the science final. ______

b. While Juan was in the library Chloe wanted to use his phone to text her boyfriend but he didn't give it to her. ______

c. Chloe is a kind girl who likes to help her friends. ______

d. Juan thwarted Chloe's underhanded plot to help Robert cheat while appearing to remain blameless. Juan remained true to his moral values. ______

e. Chloe befriended Juan not realizing that she couldn't manipulate everyone to achieve her own agenda. ______

### Example 27

### Joe's Story

Joe was at the mall with his friend Mike, when they saw Chris from their driver's ed class eating at the food court. Mike wanted to say “hello,” so the boys strode over to Sbarro's. Chris looked excited to see them as he wiped pizza sauce from his face with his sleeve. Joe noticed a big empty shopping bag by Chris' chair. As Chris gulped down his last bite of pizza, he said he was going over to Old Navy and invited the boys to go along. Swinging the shopping bag, Chris and the boys went into the store. The cashier said “Hello, Chris,” as he picked up the telephone. Joe and Mike were impressed that Chris was so well known. After a minute or two, another salesperson approached them and asked Chris if he needed some assistance. Soon, another salesperson was standing by watching the boys carefully. When a mall security guard showed up at the front door, Joe looked at Mike and said, “I think our ride is here, we'd better get going.” As they were walking out of the store, they looked back and saw the security guard moving toward Chris. The subject is then asked to identify: the Main concept; the Simple Gist; and the High-level Gist.

### Example 28

### Ethan's Car

Ethan had just turned 16 and was disappointed when his parents didn't buy him the car he thought he deserved. All his friends got new cars when they turned 16 and Ethan did not think his parents were fair. Ethan sulked for days after his June birthday, barely speaking to his parents. Three days later he called his friend Josh to ask him to take him to the mall. Josh told Ethan that he couldn't because he was working that day. “I didn't know you had a job,” replied Ethan. “That's how I help make my car payments,” Josh told him. Suddenly Ethan had an idea. He went to his mom, whom he hadn't spoken to since his birthday, and told her he wanted to get a job in order to help buy a car. His mother beamed, “We have no problem getting you a car if you'll help pay for it.” Josh was elated. The next morning he started his job search and by Friday he was gainfully employed. The subject is then asked to identify: the Main concept; the Simple Gist; and the High-level Gist.

The strategy in this step lies in using the important information and the subject's knowledge to uncover the gist. The Stepping it up step helps the subject to use his/her frontal lobes to show what you know. Getting the gist helps us concisely reduce complex material to its absolute essence.

### Example 29

### Hidden in the Dark

Josh was a shy boy who spent a lot of time alone exploring the woods behind his house. One day, when he was out exploring he noticed a deep hole in the ground next to a large, fallen tree. He ran home and told his mom about his discovery. She told him she didn't want him to go back to the woods by himself. Muttering angrily to himself, Josh went outside and sulked on the front porch. A few minutes went by before he looked up, and upon seeing some of the neighborhood boys playing across the street, he decided to ask them to go exploring with him. Even though he was a little nervous, he really wanted to go back out exploring and he didn't want to get in trouble with his mom. Josh approached the boys and asked them if they wanted to go exploring with him to look for buried treasure. The boys were very eager to join him as they imagined treasure worth a lot of money, such as gold or silver or jewels. Since it was getting dark, the boys decided to meet the next day.

Early the next morning the energetic boys gathered around the table. Josh's mom was surprised to see her kitchen full of neighborhood kids. She asked what they were planning, and Josh smugly told her they were going exploring. While sitting around the table, they checked the tools that each boy had brought from home. Bobby brought a shovel, Jim brought a flashlight with a strong beam, and Steve brought a ten-foot rope. The boys started out for their adventure together imploring Josh to show them the way.

Two hours later after briskly hiking through the woods, the boys reached the hole and saw that 3 enormous stones were blocking the entrance, it took all four boys to clear them away. Finally, using Steve's rope they lowered themselves into the dark hole to begin their spelunking adventure. The first boy went down the deep hole, then the second, third and fourth boys went down towards the dark.

The hole led to a passageway, they imagined disturbing bats or bears or scary wildlife so they crept along until they came to large open area. The beam of their flashlight lit up the walls and they were amazed to see colorful paintings. Men were depicted riding horses with bows and arrows drawn upon red buffalo, yellow deer, and brown bears. Jim shined the flashlight along the back of the opening and the boys gasped when they saw a bright white sphere sticking through the dirt. The boys rushed over and carefully used the shovel to uncover a bear skull!

Josh was afraid the other boys would be disappointed that they didn't find gold or jewels on their spelunking adventure. He reflected on how excited they had been as they hiked through the woods and chatted about how rich they would be. Now he was worried that they thought the exploration was more trouble than it was worth. He was happily surprised when they invited him to go skateboarding when they got back. Josh knew he had uncovered more than he expected that day.

The subject is then asked to: read the story through; BOUNCE out the unimportant information; UNCOVER any hidden meanings; CUSTOMIZE and LINK important details into a main concept in your own words; and Step it up and state the overall gist of each episode.

Episode 1. Josh was a shy boy who spent a lot of time alone exploring the woods behind his house. One day, when he was out exploring he noticed a deep hole in the ground next to a large, fallen tree. He ran home and told his mom about his discovery. She told him she didn't want him to go back to the woods by himself. Muttering angrily to himself, Josh went outside and sulked on the front porch. A few minutes went by before he looked up, and upon seeing some of the neighborhood boys playing across the street, he decided to ask them to go exploring with him. Even though he was a little nervous, he really wanted to go back out exploring and he didn't want to get in trouble with his mom. Josh approached the boys and asked them if they wanted to go exploring with him to look for buried treasure. The boys were very eager to join him as they imagined treasure worth a lot of money, such as gold or silver or jewels. Since it was getting dark, the boys decided to meet the next day. For Episode 1, the subject is asked to identify the Trigger Word(s), the Main Concept and the overall gist.

Episode 2. Early the next morning the energetic boys gathered around the table. Josh's mom was surprised to see her kitchen full of neighborhood kids. She asked what they were planning, and Josh smugly told her they were going exploring. While sitting around the table, they checked the tools that each boy had brought from home. Bobby brought a shovel, Jim brought a flashlight with a strong beam, and Steve brought a ten-foot rope. The boys started out for their adventure together imploring Josh to show them the way. For Episode 2, the subject is asked for Trigger Word(s), the Main Concept, and the overall gist,

Episode 3. Two hours later after briskly hiking through the woods, the boys reached the hole and saw that 3 enormous stones were blocking the entrance, it took all four boys to clear them away. Finally, using Steve's rope they lowered themselves into the dark hole to begin their spelunking adventure. The first boy went down the deep hole, then the second, third and fourth boys went down towards the dark.

The hole led to a passageway, they imagined disturbing bats or bears or scary wildlife so they crept along until they came to large open area. The beam of their flashlight lit up the walls and they were amazed to see colorful paintings. Men were depicted riding horses with bows and arrows drawn upon red buffalo, yellow deer, and brown bears. Jim shined the flashlight along the back of the opening and the boys gasped when they saw a bright white sphere sticking through the dirt. The boys rushed over and carefully used the shovel to uncover a bear skull! For Episode 3, the subject is asked to determine the Trigger Word(s), the Main Concept; and the overall gist.

Episode 4. Josh was afraid the other boys would be disappointed that they didn't find gold or jewels on their spelunking adventure. He reflected on how excited they had been as they hiked through the woods and chatted about how rich they would be. Now he was worried that they thought the exploration was more trouble than it was worth. He was happily surprised when they invited him to go skateboarding when they got back. Josh knew he had uncovered more than he expected that day. For Episode 4, the subject is asked to determine the Trigger Word(s), the Main Concept; and the overall gist.

Lesson: What lesson can we learn from the boys' experience?

Now use your main concepts to Step it up!

Write a summary using each of your main concepts and gist statements.

Add information about what the boys learned from their experience.

Read your summary out loud—Ask yourself:
Is all the important information there?
Is it in your own words?
Are all the episodes complete with a main concept?
Did you include the gist statement for each episode?

The brain learns best when the understanding is stepped up to a higher level. This is done by zooming in and zooming out to help see the forest instead of just the trees. For example the subject can be asked questions like,

Do you remember what seeing the “forest for the trees” represent? ______

What do the trees represent? ______

What does the forest represent? ______

Why do you think it's important to see or understand the big picture? ______

The SMART program described herein encourages the subject to process the information deeply. The step of “processing deeply” involves:
Showing the analysis (UNCOVER IT)
Getting the point across (CUSTOMIZE IT!)
Combining the information into main concepts (LINK IT!)
Understanding the take home message (FLEX IT!)
Learning (Step it UP!)

Step it up-Zoom In to the DETAILS to determine the MAIN CONCEPT, then Zoom Out to get the GIST.

Summarizing information with main concepts and gist helps you learn better and helps your brain be more efficient.

Using your strategies for schoolwork will help the student and the more one practices using the strategies, the quicker it gets. After a while, one won't even have to think about them, because it would become a habit.

A strategy is a plan of action to achieve a goal. Strategies are used to make solving problems easier. Strategies help us formulate the gist. To formulate the gist, one takes the important information and use one's frontal lobes to combine it with what one knows from past experiences. Gist helps one to understand the deeper implication or what is implied but not directly stated.

To show how the strategies can work with real homework the inventors take a chapter from a school history book

### Example 30

This chapter is about the Civil War. The Civil War was the war that was started because the Southern states wanted to have slaves and the Northern states were against slavery. The Southern states wanted to form their own country so they could have their own laws. The Northern states wanted the U.S. to stay together.

The Southern soldiers were called Confederate Soldiers. The Northerners were called “Unionists” . . . think about that word . . . look at its parts—“union”—what does union signify? ______

Why would the Northerners be called Unionists? ______

Northerners are also sometimes called Yankees.

The subject is encouraged to use strategies to uncover parts of the text . . . .

### 1. “Disagreement About the War”

What does it refer to when it says that, “Confederate soldiers began to leave the army in increasing numbers. By the end of the year, the confederate army had lost nearly 40 percent of its men. Some of these men were on leave, but many others were deserters.”? ______

What did he mean when the Southern governor said, “I am still a rebel . . . no matter who may be in power.”? Think about it . . . what is a rebel? ______

Do you think that meant the governor would follow all the laws of the new government the South wanted to create? ______

Why would people not following the laws be a problem? ______

Lincoln was president of the US during the Civil War, so he was considered a Northerner. What does it mean by “Lincoln's opponents”? Were they for the war or against it? ______

Look at the cartoon drawing on page 492. If the woman in the picture represents the Union what do the snakes with men's heads represent? ______

Why were they called “Copperheads?” ______

Use the questions and answers to write a main concept for the topic “Disagreement About the War” ______

Write a gist statement for the topic “Disagreement About the War” ______

### 2. “The Draft Laws”

“As the war dragged on, both the North and the South needed more soldiers. As a result, both sides passed laws of conscription also known as the draft. These laws required men to serve in the military.” What is the “draft”? ______

Does being drafted mean you are volunteering or you are being forced to be a soldier?

So, what did the laws of conscription do? ______

“In addition, wealthy men could hire substitutes to serve in their place. By 1863, substitutes might cost as much as $6,000. The fact that wealthy men could avoid service caused poor southerners to complain that it was a ‘rich man's war but a poor man's fight.’” What does that quote mean? ______

“Like the Confederacy, the Union allowed draftees to hire substitutes. However, the North also offered $300 bounties or cash payments, to men who volunteered to serve. As a result, only a small percentage of men in the North were drafted. Most men volunteered and received the bounty.” Why do you think that the North didn't have to draft as many soldiers? ______

Who do you think were happier? The soldiers who were drafted from the South or the soldiers who volunteered from the North? ______ why? ______

Did the people from the North like the draft? ______

Use the questions and answers to write a main concept for the topic “The Draft Laws” ______

Write a gist statement for the topic “The Draft Laws” ______

### 3. “Economic Effects of the War”

“Food shortages were common in the South, partly because so many farmers were fighting the Confederate army.” Why would that mean that there wasn't enough food?______

“Over the course of the war, prices rose 9,000 percent.” So if a pack gum cost 10 cents at the beginning of the war, what would it have cost if the price rose 9,000%? ______

“During the war, the federal government passed two important economic measures. In 1861, it established the first income tax.” What is an income tax? ______

“The following year, the government issued a new paper currency known as greenbacks because of their color.” What do you think a “greenback” is? Do we still use “greenbacks” today? ______

“Some Southerners in the border states took advantage of the stronger Union economy by selling cotton to Northern traders, in violation of Confederate law. ‘Yankee gold,’ wrote one Confederate officer, ‘is fast accomplishing what Yankee arms could never achieve—the subjugation of our people.’” Think about what that means. Why do you think that people in the South broke the new laws? ______

What does it mean when it says that “Yankee gold is accomplishing what Yankee arms could never achieve.?” Can you uncover the word subjugation? ______

Use the questions and answers to write a main concept for the topic “The Draft Laws”

Write a gist statement for the topic “The Draft Laws”

Now describe what the first part of the chapter is about by Stepping it up! Use each of your main concepts and gist statements to formulate a summary.

What can we learn from this part of the Civil War?

### Example 31

### Three Questions By: Leo Tolstoy

It once occurred to a certain king, that if he always knew the right time to begin everything; if he knew who were the right people to listen to, and whom to avoid; and, above all, if he always knew what was the most important thing to do, he would never fail in anything he might undertake.

And this thought having occurred to him, he had it proclaimed throughout his kingdom that he would give a great reward to anyone who would teach him what was the right time for every action, and who were the most necessary people, and how he might know what was the most important thing to do.

And learned men came to the King, but they all answered his questions differently.

In reply to the first question, some said that to know the right time for every action, one must draw up in advance, a table of days, months and years, and must live strictly according to it. Only thus, said they, could everything be done at its proper time. Others declared that it was impossible to decide beforehand the right time for every action; but that, not letting oneself be absorbed in idle pastimes, one should always attend to all that was going on, and then do what was most needful. Others, again, said that however attentive the King might be to what was going on, it was impossible for one man to decide correctly the right time for every action, but that he should have a Council of wise men, who would help him to fix the proper time for everything.

But then again others said there were some things which could not wait to be laid before a Council, but about which one had at once to decide whether to undertake them or not. But in order to decide that, one must know beforehand what was going to happen. It is only magicians who know that; and, therefore, in order to know the right time for every action, one must consult magicians.

Equally various were the answers to the second question. Some said, the people the King most needed were his councilors; others, the priests; others, the doctors; while some said the warriors were the most necessary.

To the third question, as to what was the most important occupation: some replied that the most important thing in the world was science. Others said it was skill in warfare; and others, again, that it was religious worship.

All the answers being different, the King agreed with none of them, and gave the reward to none. But still wishing to find the right answers to his questions, he decided to consult a hermit, widely renowned for his wisdom.

Episode 1—Gist: ______

Trigger word: ______

Main Concept: ______

The hermit lived in a wood which he never quitted, and he received none but common folk. So the King put on simple clothes, and before reaching the hermit's cell dismounted from his horse, and, leaving his body-guard behind, went on alone.

When the King approached, the hermit was digging the ground in front of his hut. Seeing the King, he greeted him and went on digging. The hermit was frail and weak, and each time he stuck his spade into the ground and turned a little earth, he breathed heavily.

The King went up to him and said: “I have come to you, wise hermit, to ask you to answer three questions: How can I learn to do the right thing at the right time? Who are the people I most need, and to whom should I; therefore, pay more attention than to the rest? And, what affairs are the most important, and need my first attention?”

The hermit listened to the King, but answered nothing. He just spat on his hand and recommenced digging.

“You are tired,” said the King, “let me take the spade and work awhile for you.” “Thanks!” said the hermit, and, giving the spade to the King, he sat down on the ground.

When he had dug two beds, the King stopped and repeated his questions. The hermit again gave no answer, but rose, stretched out his hand for the spade, and said: “Now rest awhile—and let me work a bit.” But the King did not give him the spade, and continued to dig. One hour passed, and another. The sun began to sink behind the trees, and the King at last stuck the spade into the ground, and said: “I came to you, wise man, for an answer to my questions. If you can give me none, tell me so, and I will return home.”

“Here comes someone running,” said the hermit, “let us see who it is.”

Episode 2—Gist: ______

Trigger word: ______

Main Concept: ______

The King turned round, and saw a bearded man come running out of the wood. The man held his hands pressed against his stomach, and blood was flowing from under them. When he reached the King, he fell fainting on the ground moaning feebly. The King and the hermit unfastened the man's clothing. There was a large wound in his stomach. The King washed it as best he could, and bandaged it with his handkerchief and with a towel the hermit had. But the blood would not stop flowing, and the King again and again removed the bandage soaked with warm blood, and washed and re-bandaged the wound. When at last the blood ceased flowing, the man revived and asked for something to drink. The King brought fresh water and gave it to him. Meanwhile the sun had set, and it had become cool. So the King, with the hermit's help, carried the wounded man into the but and laid him on the bed. Lying on the bed the man closed his eyes and was quiet; but the King was so tired with his walk and with the work he had done, that he crouched down on the threshold, and also fell asleep—so soundly that he slept all through the short summer night.

Episode 3—Gist: ______

Trigger word: ______

Main Concept: ______

When he awoke in the morning, it was long before he could remember where he was or who was the strange bearded man lying on the bed and gazing intently at him with shining eyes.

“Forgive me!” said the bearded man in a weak voice, when he saw that the King was awake and was looking at him. “I do not know you, and have nothing to forgive you for,” said the King. “You do not know me, but I know you. I am that enemy of yours who swore to revenge himself on you, because you executed his brother and seized his property. I knew you had gone alone to see the hermit, and I resolved to kill you on your way back. But the day passed and you did not return. So I came out from my ambush to find you, and I came upon your bodyguard, and they recognized me, and wounded me. I escaped from them, but should have bled to death had you not dressed my wound. I wished to kill you, and you have saved my life. Now, if I live, and if you wish it, I will serve you as your most faithful slave, and will bid my sons do the same. Forgive me!”

The King was very glad to have made peace with his enemy so easily, and to have gained him for a friend, and he not only forgave him, but said he would send his servants and his own physician to attend him, and promised to restore his property.

Having taken leave of the wounded man, the King went out into the porch and looked around for the hermit. Before going away he wished once more to beg an answer to the questions he had put. The hermit was outside, on his knees, sowing seeds in the beds that had been dug the day before.

The King approached him, and said: “For the last time, I pray you to answer my questions, wise man.” “You have already been answered!” said the hermit, still crouching on his thin legs, and looking up at the King, who stood before him. “How answered? What do you mean?” asked the King. “Do you not see,” replied the hermit. “If you had not pitied my weakness yesterday, and had not dug those beds for me, but had gone your way, that man would have attacked you, and you would have repented of not having stayed with me. So the most important time was when you were digging the beds; and I was the most important man; and to do me good was your most important business. Afterwards when that man ran to us, the most important time was when you were attending to him, for if you had not bound up his wounds he would have died without having made peace with you. So he was the most important man, and what you did for him was your most important business. Remember then: there is only one time that is important—Now! It is the most important time because it is the only time when we have any power. The most necessary man is he with whom you are, for no man knows whether he will ever have dealings with anyone else: and the most important affair is, to do him good, because for that purpose alone was man sent into this life!”

Episode 4—Gist: ______

Trigger word: ______

Main Concept: ______

Now use your main concepts to Step it up! Write a summary linking your main concepts AND gist statements.

Read your summary out loud—Ask yourself:
Is all the important information there?
Is it in your own words?
Are all the episodes complete with a good main concept?
Did you include your gist statement for each episode?

The SMART program of the present invention described hereinabove can also be adapted for maintaining cognitive functions in adult life and as one gets progressively older. Maintaining cognitive function requires more effort when one is in his/her 60's and 70's. In the Strategic Memory and Reasoning Training (SMART) program of the instant invention teaches strategies that help adults use the frontal lobes of the brain. The frontal lobes are targeted because they are the last area of the brain to develop and the first to show decline with age. The frontal lobes are extremely important because they help with the high-level thinking skills such as problem solving, reasoning, and decision-making: critical skills to remain independent with age. The more one uses the frontal lobes the stronger they become. The SMART program emphasizes meta cognition. In other words, it teaches one to think about thinking or think about how information is processed. Using meta cognitive activities related to each strategy, the subject learns to rate his/her own thinking ability and consider ways to think more deeply which in turn engages the frontal lobes.

The SMART program described herein below addresses three main thinking processes that have been shown to be critical for efficient brain function:

I. Strategic Attention: Blocking distractions and leaving what is most important.
II. Integrative Reasoning: Taking in new information, abstracting the big ideas and putting it in one's own words, effectively integrating new information with what one already knows.
III. Innovative Problem Solving: Coming up with new ways to understand or apply information

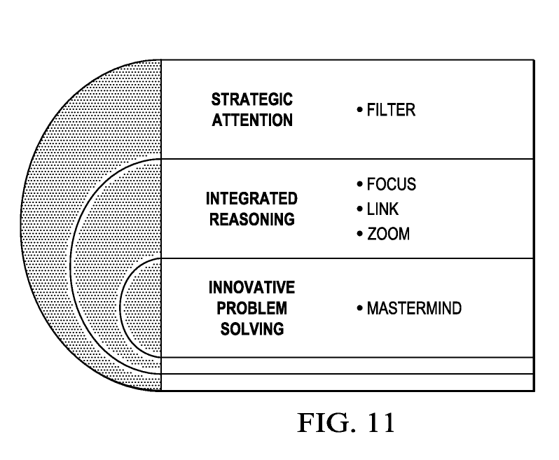

The SMART program describes strategies that will enhance each of the cognitive processes listed above. The strategies are also listed in Table 2 and are represented schematically in FIG. 11.

### Strategic Attention: Filter

The first strategy is FILTER which augments strategic attention. When one FILTER's one blocks extraneous or repeated information so that one can concentrate on main ideas, themes, important actions or facts related to the topic that emerge. The brain learns best when one blocks extraneous information so you concentrate on what is most helpful information that conveys the global concept. There are many ways that one can use this strategy every day.

To help with filtering the subject is asked to read the text one time through to determine what it's all about and to write down a few words that explain what the main idea of the text is. The subject is then instructed to read the text again looking for information to delete and mark out information that is not needed to understand the main idea of the text.

The subject is then asked to rate his/her own thinking by using the following rating system:

0=Deleted nothing from the text. Everything seemed important.
1=Deleted up to 25% from the text but most details seemed important.
2=Deleted at least 50% from the text. Most details not important to convey core meaning.

TABLE 2
Adult SMART brain training.

| Frontal Lobe | | | |
|---|---|---|---|
| Function | | | |
| (Process) | Strategy | Description | Illustration |
| STRATEGIC | 1. Filter | Delete unimportant details so main idea | Read article once through to get an idea what it's |
| ATTENTION | | emerges. | all about. |
| | | Hone in on bigger ideas to reveal abstracted | Delete “unimportant” information. |
| | | themes. | |
| INTEGRATION | 2. Focus | Bind important material together into | Write a sentence or two that collapses the |
| | | information chunks. | important information succinctly (main concept). |
| | | State main concepts in your own words. | |
| | 3. Link | Link information chunks with world | Write a summary that includes your interpretation. |
| | | knowledge to create an astute synopsis - an | |
| | | insightful recap. | |
| | 4. Zoom | Zoom in - zoom out to help you see the forest | Write a concise statement that explains your |
| | | instead of just the trees. Getting the gist helps | understanding of the higher level meaning of the |
| | | us concisely reduce complex material into its | text, taking outside its context. |
| | | absolute essence. Think of information in a | |
| | | broader context. | |
| INNOVATION | 5. Mastermind | Read between the lines to discover the deeper | Alternate endings to movie/book/article that |
| | | meanings and interpretations from multiple | would change entire meaning. |
| | | perspectives. | Develop different interpretations - even if you |
| | | | don't agree with them. |
| | | | Argue the case from another perspective. |

### Integrative Reasoning: Focus

The brain understands and remembers best when information is organized. Focus is used daily when learning something new, planning and organizing, and carrying out everyday life activities. For instance, if one has many tasks to complete in one day, it is much easier to remember all that one needs to do when one plans out his/her day in advance. Rather than making one long list of disparate items, one can organize one's day by chunking activities according to their location, type of activity or temporal sequence. This is an example of a very basic level Focus activity.

In SMART, the subject uses this strategy in relation to texts that he/she reads. There are many different types of texts, and every text has possibilities for organization by aspects such as time, theme, setting or action. The inventors call these chunks of information that comprise the main parts of a text Focus Concepts. In text books this is done by the editor in the form of chapters that are broken down into sections. In literature, chapters are used, in plays, scenes are used and episodes are used in movies or TV shows. When one focuses, one binds together the important material that one may have filtered into information chunks or important ideas.

To actually help the subject focus, the subject is first asked to filter out unimportant information, organize what's left by chunking into events, topics, themes, time, etc. The subject is then asked to label each aspect with a focus abstract concept that helps the subject remember what the information chunk is about. Focus concepts contain generalized ideas from the text and the subject's performance can be scored as follows:

0=FOCUS concept is not more than a word or two and is not specific to the new information.
1=FOCUS concept contains part of the new information but is vague or confusing.
2=FOCUS concept contains enough information to provide a clear understanding of the important ideas.

### Integrative Reasoning: Link

Link augments the part of the cognitive process called Integrative Reasoning. The subject processes the information by creating an astute synopsis that associates what the subject knows with what he/she has just read, which makes it their own. Link focuses concepts by connecting the new information the subject has obtained to what the subject already knows, and then stating the ideas in their own words. The more relevant knowledge and experience the subject has, the better the subject's insight can be. Summarizing and interpreting the information helps the subject to understand and process at a deeper level. The brain remembers best when new information is linked to what one already knows. The link scoring system is described below:

0=Linked information is a retell of the original text.
1=Linked information is a shortened version of what is in the text.
2=Linked information is a combination of a shortened version of what is in the text plus what I know and can infer.

### Integrative Reasoning: Zoom

Zoom is also part of the cognitive process integrative reasoning. After one filters, focuses and links, one is instructed to zoom out to glean the essence, spirit or gist of what one has inferred. Then one zooms in to support these ideas with important details. This zooming in and zooming out in strengthens the astute synopsis one has created, by highlighting the ideas one has abstracted from the original text, which are supported by important information. Zooming out helps one to see the big picture and helps to concisely reduce complex material to its absolute essence.

Zoom Out—Zoom In—boosts the dynamic cognitive process of integrative reasoning by: (i) identifying the big picture/goal, (ii) acquiring knowledge to achieve goal, and (iii) updating project/decision with new information. The scoring system is as follows:

0=Zoomed in only and used points directly from the text.
1=Zoomed out and abstracted big picture or gist but did not specifically support.
2=Zoomed out and abstracted big picture or gist and zoomed in to utilize supportive points from text.

### Innovative Problem Solving: Mastermind

Mastermind is part of the cognitive process called innovation. Mastermind is an innovative process in which one creates an interpretive statement and then goes beyond that understanding to construct an additional construal. These interpretive explanations are outside the framework of the text, coming from a different perspective or circumstance or milieu. Good interpretive statements are transformed into assertions not directly about the text. In other words, not a concrete account of the facts or details. A good interpretive statement refers to the whole text, not just a portion of it. A good interpretive statement is clear and concise. The subject is encouraged strongly to go more deeply to create different, even opposing, interpretations. When one masterminds, one is creating and innovating. In innovative thinking one pushes novel thinking and problem solving ('messy problems'), generates multiple solutions, and interprets from diverse perspectives.

The mastermind scoring system is described below:

0=Directly about the text or does not pertain to the text.
1=Not directly about the text but pertains only to part of text and is too simple or confusing.
2=Not directly about the text and pertains to entire text and is clear and concise.

A gist or an outline of the strategies and the steps undertaken (subject instructions) within each step are presented below in Table 3.

TABLE 3
Strategy outline.

| | | |
|---|---|---|
| # | Strategy | Instruction |

Strategic Attention: Block distractions and focus
on what is most important.

| | | |
|---|---|---|
| 1 | Filter | Block extraneous information so you can focus on the |
| | | relevant information. |

Integration: Take in new information, abstract the
big ideas and put it in your own words.

| | | |
|---|---|---|
| 2 | Focus | Bind important information together into larger themes |
| | | called focus concepts. |
| 3 | Link | Link focus concepts to world knowledge to create |
| | | an astute synopsis. |
| 4 | Zoom | Zoom out for the big picture and zoom in for the |
| | | supporting facts. |

Innovation: Assess issues from various perspectives and
integrate information to come up with new ideas.

| | | |
|---|---|---|
| 5 | Mastermind | Generate diverse, even opposing, abstract |
| | | interpretations, solutions or make multiple applications. |

No known test or training program has been previously designed to assess and provide strategy based instruction on gist reasoning (a higher-order form of cognitive reasoning that is highly relevant to adolescent learning and adult cognitive functioning from early to late life) like the SMART program described hereinabove. Strategic gist reasoning as defined by the present inventors is the ability to combine/bind details to form abstract gist meanings from different input sources, such as auditory, visual, and other sensory modalities.

Constructing abstract gist meaning is ecologically relevant from adolescence until the end of life, as this skill applies to activities such as reading a school assignment, making personal decisions, listening and taking notes from a lecture, watching a movie or television program or listening to a friend's joke. In fact, remembering the abstracted gist meaning from insurance agents or class readings, for example, may be one of the most important cognitive functions that supports depth of understanding and efficiency of learning rather than recalling the specific facts. Furthermore, these two meanings levels have been shown to be independent of one another and contribute differentially to decision making.

One impressive feat of the human brain is the expanding capacity to construct abstract gist meanings from the vast amount of incoming information/stimuli to which one is exposed daily, with new evidence that the capacity is primed to significantly expand during adolescence, however this cognitive capacity is losing ground or eroding in the school system, in the work place, and at retirement or old age. The present inventors have shown that the meaning is most robustly used when it is synthesized to a more generalized gist-based meaning rather than trying to remember the verbatim details.

The components of SMART and TOSL were each built on a unique theoretical framework comprising of three processes representing cognitive core capacities underlying the ability to engage in strategic gist reasoning, which have been previously listed hereinabove. These include (i) strategic attention, (ii) integrated reasoning, and (iii) elaborated reasoning. The first, strategic attention, utilizes cognitive control to reduce the load of the incoming details by focusing on and encoding the important information while inhibiting less relevant information. By fifth grade, students are capable of condensing familiar information by deleting the trivial details and leaving only the most important facts. When individuals attempt to attend to and retain all incoming information at the same level, working memory and other cognitive resources become overloaded and inefficient. The second major process, integrated reasoning, combines explicit and important facts to form higher-order abstracted meanings that are not explicitly stated in the stimuli/text. This capacity to abstract novel meanings is illustrated symbolically by a +b=c, where “a” and “b” are explicit facts and “c” represents the cognitive-linguistic construction of a novel, unstated, generalized meaning that while derived from the facts is not explicitly stated. Integrated reasoning is achieved by integrating the explicit content in the context of one's own concepts by conveying the ideas into one's own words, combining these ideas with pre-existing knowledge to form more global, gist-based representations. This construction of gist meaning is captured by the widely used saying: “the whole is more than the sum of its parts”. The third key process, elaborated reasoning, draws on fluency and fluidity of thinking to derive multiple abstract interpretations and/or generalized applications beyond the explicit content to other contexts. The gist reasoning training of the instant invention is outlined in Table 4.

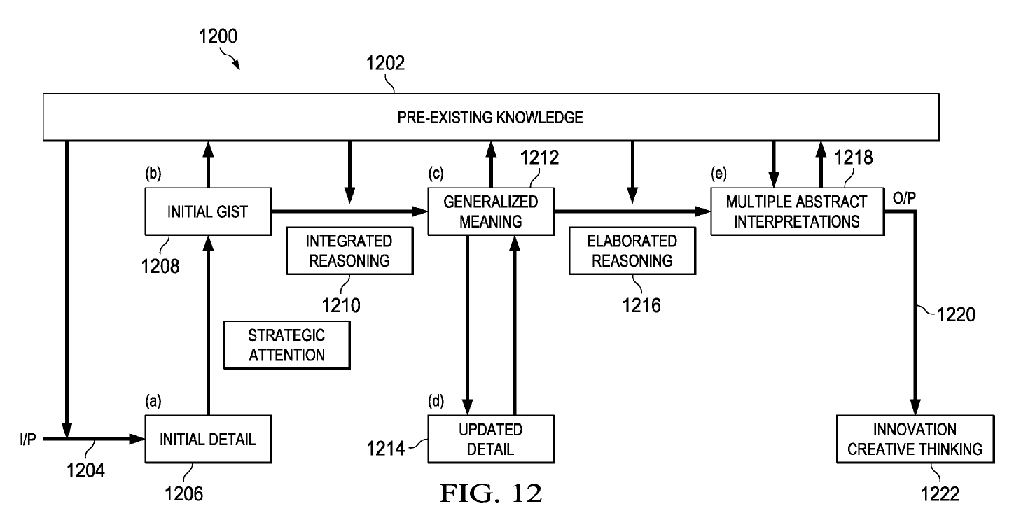

FIG. 12 provides the schematic 1200 of the unique program of the present invention illustrating the dynamic, bidirectional flow in the three key processes (outlined above) by which gist-based meanings from texts or verbal talks/lectures are derived from the incoming details. At the initial stage 1204, the incoming explicit details are processed with reference to pre-existing knowledge 1202. Once sufficient initial details 1206 are encoded and comprehended from the input information, an initial gist representation 1208 is generated. This initial gist representation 1208 is generated in a bottom-up approach by strategically attending to and combining important details while inhibiting trivial details. In the intermediate stage, the initial gist 1208 is further refined when combined with world knowledge through integrated reasoning 1210 to generate a novel generalized meaning 1212. This generalized meaning 1212 is not explicitly stated but rather is derived by updating incoming facts in the context of world knowledge 1202. The generalized meaning 1212 is used in a top-down fashion to verify and update the details of the incoming information 1214 that is being processed. Similarly, the updated details 1214 will influence generalized meaning 1212 in a bottom-up approach as long as the incoming information stream continues. In the later stage, the novel generalized meaning 1212 is further generalized to derive multiple abstract interpretations 1218 that are relevant to new contexts through the use of elaborated reasoning 1216.

TABLE 4
Gist Reasoning Training in Adults.

| Session | Strategy | Brief Description | Instruction/Activity |
|---|---|---|---|
| 1 | Inhibit | Deletion of unimportant or extraneous | Read text more than once to get a general sense of what it's |
| | | information, allowing important information | about. Delete extraneous information leaving ideas that go |
| | | conveying global theme to emerge. | together to communicate important points. Using texts of high |
| | | | complexity, participants draw a line through information that is |
| | | | extraneous to its global theme. Read what remains to determine if |
| | | | more or less deletion is necessary. |
| 2 | Organize | Organization of information into a | Chunk important information into own words to write down 2-3 |
| | | purposeful sequence, by focusing on | key concepts to create a framework for summary of complex |
| | | concepts or themes abstracted from the text. | text. |
| 3 | Inference | Binding information across adjacent | Use inference to integrate the key concepts to write a concise |
| | | sentences/information units to fill in the | synopsis of the text |
| | | gaps and read between lines | |
| 4 | Generalize | Integrate newly encountered information in | Write down deeper meanings about text in relation to world |
| | | the context of life experience and world | knowledge with an eye toward innovation, creation, |
| | | knowledge to construct broader meanings | interpretation, multiple solutions, and diverse perspectives. Write |
| | | than conveyed by the explicit content. | down interpretive statement as a part of the summary. |
| 5-8 | All | | Apply all the above strategies to process information using gist |
| | strategies | | reasoning when reading complex articles and books, watching |
| | | | movies and plays, attending art exhibits, and working on projects |
| | | | related to real life activities |

Each of the first four training sessions highlights one strategy. Since each strategy builds on the other, the training is additive in nature.

Relevance to Adults: Loss of mental productivity in the workplace is one of the greatest costs burdens to corporations around the world, estimating economic losses in the trillions of dollars. Cognitive decline is a key factor that threatens functionality and quality of life in seniors. Strategic gist reasoning is critical to high levels of maintained cognitive function, independent thinking, and decision making with age but is vulnerable to lack of use as well as the earliest pathological changes in the brain such as in mild cognitive impairment. Studies involving individuals with fronto-temporal dementia and adults with traumatic brain injury suggest that gist reasoning relies heavily on the integrity of frontal cortices and its extensive reciprocal connections with other cortical and subcortical structures similar to that of executive functions. Empirical evidence indicates that gist reasoning incorporates components of executive functions such as selective attention and inhibition, all of which engage top-down cognitive control processes. Thus, a strategy-based approach to training gist reasoning might not only strengthen abstraction skills in seniors but might generalize to untrained executive functions that are engaged during gist reasoning.

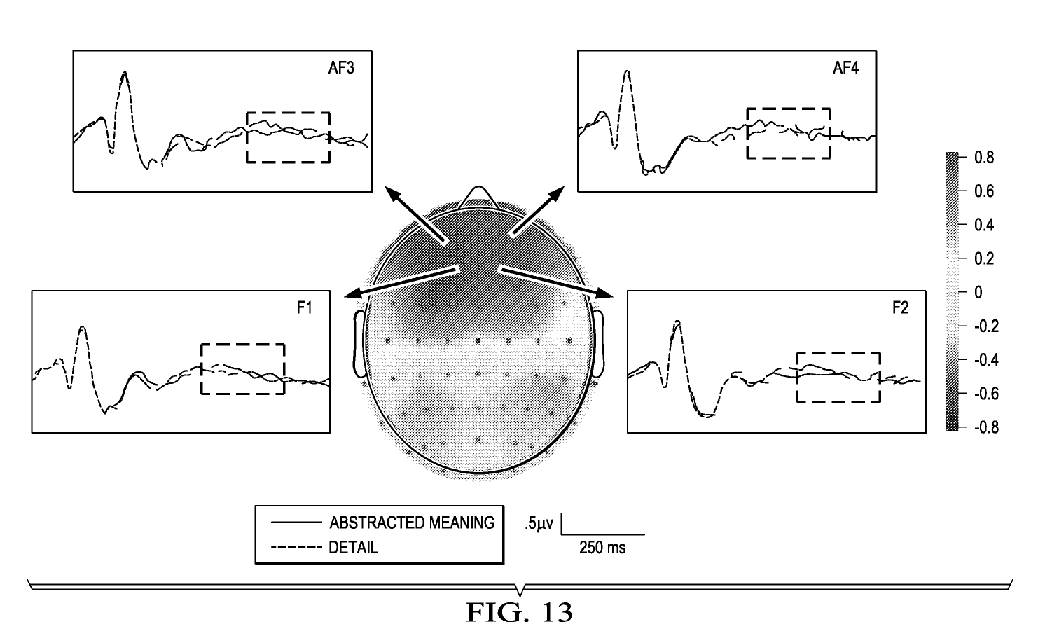

Researchers have found a positive correlation between perfusion in right frontal regions and higher gist abstraction abilities in eight children three years after sustaining a brain injury in a resting-state using a single photon emission computerized tomography (SPECT) study. The present inventors found similar relationships between gist scores and regional cerebral perfusion in the right frontal regions in a resting state in a SPECT study involving individuals with frontotemporal lobar degeneration. The present inventors further examined the underlying neural basis of processing gist versus details in two separate studies, one using event-related potentials (ERPs) and the other using functional magnetic resonance imaging (fMRI) in young adults. Participants in both studies judged whether a given statement corresponded to gist or details conveyed in complex digital pictures while collecting either ERP or fMRI data. The event-related potentials study revealed differences between gist and detail processing between 690-1070 ms over bilateral frontal regions (FIG. 13).

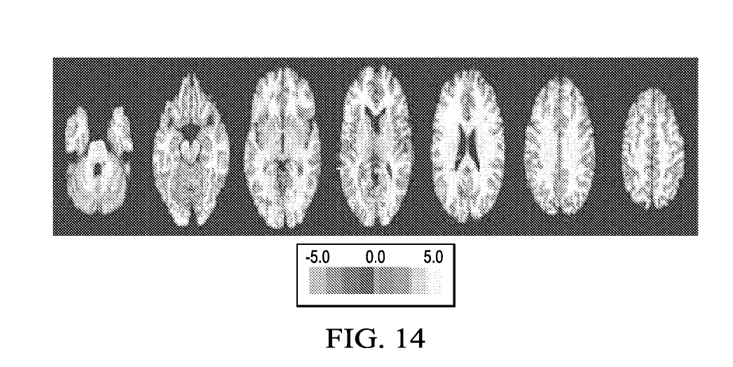

In the fMRI study, greater activation for the gist condition was observed primarily in left supramarginal, bilateral superior frontal along the anterior medial aspect, and bilateral inferior frontal brain regions. Greater activation for details was observed primarily in bilateral inferior and superior parietal, dorsolateral prefrontal and lateral occipital complex regions (FIG. 14). Overall, the results suggested that gist processing engages different brain regions than does identifying details, with the greatest differences being in frontal regions during gist processing.

The findings presented hereinabove underlines the significant role of the frontal lobe regions and their reciprocal connections. Frontal lobes undergo extensive remodeling and growth during adolescence and hence the worked presented herein can be used to explore the correspondence between development of strategic gist reasoning and adolescent brain development, specifically related to frontal networks and their elaborate connections across brain regions. Frontal lobe function is the first to decline with normal aging, hence the relationship between SMART and changes in frontal connectivity and activation patterns studied using EEG and fMRI can provide very valuable insights regarding aging, cognitive functions, general health of the brain etc. Further, using brain imaging techniques one can examine those who fail to develop gist reasoning, as well as those who develop average to high performance on gist reasoning tasks.

The present invention describes a SMART program. The SMART program is a novel cognitive intervention that teaches children and adults alike to understand and construct general meaning or gist through reasoning. The SMART program teaches children strategies to improve brain efficiency through organization, synthesis, abstraction and interpretation of meaning. The SMART program also helps to enhance one or more cognitive processes selected from brain functions, problem solving skills, high-level thinking skills, reasoning skills or combinations thereof in adults particularly in senior citizens.

It is contemplated that any embodiment discussed in this specification can be implemented with respect to any method, kit, reagent or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C or combinations thereof” is intended to include at least one of: A, B, C, AB, AC, BC or ABC, and if order is important in a particular context, also BA, CA, CB, CBA, BCA, ACB, BAC or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

U.S. Patent Application Publication No. 20080220399: Cognitive Educational Tool for Effectuating Learning.
U.S. Pat. No. 5,980,354: Storyboard Toys for Nurturing Cognition and Learning Strategies.

1-8. (canceled)

9. A system for enhancing one or more cognitive processes in a subject, comprising:
a delivery device that provides or displays a reading segment having known information, wherein the delivery device is selected from the group consisting of a data processor, a display, a computer, a phone, a smartphone, a television, a video, a DVD, a CD, a Blu-ray disc, a media storage device, a photograph, a web-based system, and combinations and modifications thereof; and
one or more electronic worksheets for documenting the subject's responses to one or more of the following tasks:
inhibit/select or delete/inhibit unimportant details and prioritize important information from the reading segment and documenting the subject's prioritization response;
organize important information from the reading segment into a hierarchical listing and documenting the subject's organization response;
generate an inference to extract a deeper/abstract meaning of information in the reading segment and documenting the subject's inference response;
paraphrase in their own words the subject matter disclosed in the reading segment and documenting the subject's paraphrase response;
combine and connect details from reading segment; combine details together into one or more concepts, using inferencing and paraphrasing, and documenting the subject's concept response;
integrate the subject's previous knowledge with new information from reading segment to formulate a high-level concepts, and documenting the subject's integration response; and
generalize the abstract ideas with supporting key points from the reading segment, and documenting the subject's generalization response.

10. The system of claim 9, wherein each step is conducted in a different work session.

11. The system of claim 9, wherein one or more steps are conducted in one or more work sessions.

12. The system of claim 9, wherein each step is conducted in a single work session.

13. The system of claim 9, wherein each step is documented on one or more worksheets.

14. The system of claim 9, wherein the reading segment comprises a book, a magazine, an article, a newspaper, a paper based reading material, an electronic book, a local computer or computer program, a web-based computer program, a video, a sound, a picture, a photograph, and combinations and modifications thereof.

15. The system of claim 9, wherein the reading segment comprises one or more stories.

16. The system of claim 9, further comprising the step of selecting the reading segments based on a reading level of the subject.

17. A system for enhancing one or more cognitive processes in a subject, comprising:
a reading segment module comprising one or more stories;
a documentation module comprising one or more worksheets for documenting the subject's responses to one or more of the following modules based on the one or more stories:
an inhibit/select delete/inhibit module that comprises worksheets for documenting the subject's answers to questions that define unimportant details and prioritization information;
an organizational module that comprises worksheets for documenting the subject's answers to questions that define a hierarchical listing;
an inference module that comprises worksheets for documenting the subject's answers to questions that define a deeper/abstract meaning of information in the reading segment;
a paraphrasing module that comprises worksheets for documenting the subject's paraphrase of the one or more stories;
a combination and connection module that comprises worksheets for documenting the subject's answers to questions that combine one or more details from the reading segment together with one or more concepts, using inferencing and paraphrasing;
an integration module that comprises worksheets for documenting the subject's answers to questions that document the subject's previous knowledge with new information from the reading segment to formulate a high-level concepts; and
a generalization module that comprises worksheets for documenting the subject's answers to questions that document the subject's understanding of abstract ideas with supporting key points from the reading segment.

18. The system of claim 17, wherein each step is conducted in a different work session.

19. The system of claim 17, wherein one or more steps are conducted in one or more work sessions.

20. The system of claim 17, wherein each step is conducted in a single work session.

21. The system of claim 17, wherein each step is documented on one or more worksheets.

22. The system of claim 17, wherein the reading segment comprises a book, a magazine, an article, a newspaper, a paper based reading material, an electronic book, a local computer or computer program, a web-based computer program, a video, a sound, a picture, a photograph, and combinations and modifications thereof.

23. The system of claim 17, wherein the reading segment comprises one or more stories.

24. The system of claim 17, further comprising the step of selecting the reading segments based on a reading level of the subject.

25. A computer based system for enhancing one or more cognitive processes, improving reasoning, promoting critical thinking or combinations thereof in a subject comprising:
a Strategic Memory and Reasoning Training (SMART) program or module comprising:
a reading segment module comprising one or more stories;
a documentation module comprising one or more worksheets for documenting the subject's responses to one or more of the following modules based on the one or more stories:
an inhibit/select delete/inhibit module that comprises worksheets for documenting the subject's answers to questions that define unimportant details and prioritization information; an organizational module that comprises worksheets for documenting the subject's answers to questions that define a hierarchical listing;
an inference module that comprises worksheets for documenting the subject's answers to questions that define a deeper/abstract meaning of information in the reading segment;
a paraphrasing module that comprises worksheets for documenting the subject's paraphrase of the one or more stories;
a combination and connection module that comprises worksheets for documenting the subject's answers to questions that combine one or more details from the reading segment together with one or more concepts, using inferencing and paraphrasing;
an integration module that comprises worksheets for documenting the subject's answers to questions that document the subject's previous knowledge with new information from the reading segment to formulate a high-level concepts; and
a generalization module that comprises worksheets for documenting the subject's answers to questions that document the subject's understanding of abstract ideas with supporting key points from the reading segment;
a training module, server, program, an add-on or combinations and modifications thereof in two-way communication with the SMART program, wherein the training module is programmed or comprises information selected from the group consisting of the subject's academic grade, age, interest and a focus area, wherein the training module transmits and receives information from the SMART program;
a record's module, server, program, an add-on or combinations and modifications thereof in two-way communication with the SMART program, wherein the record's module is programmed or comprises information selected from the group consisting of subject demographics, payment status, test results, progress status, and treatment plan, wherein the training module transmits and receives information from the SMART program;
an assessment module, server, program, an add-on or combinations and modifications thereof in two-way communication with the SMART program, wherein the assessment module receives one or more test results from the SMART program and matches the results continuously with a database of test scores, wherein one or more results of the matching are transmitted back to the SMART program;
a results database or server connected to the SMART program, wherein one or more test results of the subject are stored in the database or the server; and
a relationship module, server, program, an add-on or combinations and modifications thereof in two-way communication with the SMART program, wherein the relationship module receives one or more test results and assessments from the SMART program and transmits updated assessments, emails, and teaching resource information back to the SMART program.

26. The system of claim 25, further comprising a system for scoring, moderating, monitoring, and providing feedback to the computer based system, wherein the system is in direct two-way communication with the records module, server or program.

27. The system of claim 25, wherein the system provides feedback to a community forum, focus group, a social ratings group or combinations and modifications thereof.

28. The system of claim 25, wherein the system comprises an electronic monitoring system, a human subject, a database, a computer program or combinations and modifications thereof.

29. The system of claim 25, wherein the relationship module is in two-way communication with the community forum, the focus group, the social ratings group or combinations and modifications thereof.

30. The system of claim 25, wherein the system is a local computer or computer program, a web-based computer program, a video, a DVD, a CD, a Blu-ray disc, a media storage device, a phone, a smartphone, and combinations and modifications thereof.

31-42. (canceled)

43. A system for enhancing one or more cognitive processes in a subject, comprising:
a reading segment module comprising one or more stories, newspaper articles, magazine articles, literary works, current affairs, pictures, images, cartoons and combinations thereof;
a documentation module comprising one or more worksheets for documenting the subject's responses to one or more of the following modules based on the reading segment modules;
a filtering/blocking out/deleting module that comprises worksheets for documenting the subject's answers to questions that define unimportant details and prioritization information;
a focusing module that comprises worksheets for documenting the subject's answers to questions that define an organizational ability;
an integration module that comprises worksheets for documenting the subject's answers to questions that document the subject's previous knowledge with new information from the reading segment to formulate a high-level concepts
a synopsis module that comprises worksheets for documenting the subject's answers to questions that define an interpretation of information in the reading segment; and
a discovery module that comprises worksheets for documenting the subject's deeper understanding of the reading segment.

44. The system of claim 43, wherein the subject is an adult human subject.

45. The system of claim 43, wherein the one or more cognitive processes comprise brain functions, problem solving skills, high-level thinking skills, reasoning skills or combinations thereof.
